(19) United States
(12) Patent Application Publication
(10) Pub. No.: US 2026/0301488 A1
(43) Pub. Date: Oct. 1, 2026

(54) ELECTRONICALLY CONTROLLED DOOR LOCK SYSTEMS FOR ELECTRONIC GAMING MACHINES

(71) Applicant: Aristocrat Technologies, Inc., Las Vegas, NV (US)

(72) Inventors: Jacob Romanek, Lebanon, NJ (US); Eric Taylor, Las Vegas, NV (US)

(21) Appl. No.: 19/096,468

(22) Filed: Mar. 31, 2025

(51) Int. Cl. G07C 9/00; G07F 17/32

(52) U.S. Cl. CPC G07C 9/00182; G07C 9/00571; G07C 9/00896; G07F 17/3223

(57) ABSTRACT

Systems for electronically locking and unlocking locks of an electronic gaming machine are provided. Some systems have a controller storing instructions configured to cause a processor to receive first data from wireless RF signals having the first data, determine whether the first data is associated with unlocking a first door and unlocking a first cashbox door, cause, in response to determining that the first data is associated with unlocking the first door and not associated with unlocking the first cashbox door, the first door lock mechanism to move into the first unlocked position and the cashbox door lock mechanism to remain in the second locked position, and cause, in response to determining that the first data is associated with unlocking the first cashbox door and not associated with unlocking the first door, the cashbox door lock mechanism to move into the second unlocked position.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

Electronic gaming machines are complex devices with display devices and are often housed within cabinets having multiple access points in the form of doors or trays that may be opened or slid out in order to access internal components, cables, connectors, etc.

### SUMMARY

Details of one or more implementations of the subject matter described in this specification are set forth in the accompanying drawings and the description below. Other features, aspects, and advantages will become apparent from the description, the drawings, and the claims. The following, non-limiting implementations are considered part of the disclosure; other implementations will be evident from the entirety of this disclosure and the accompanying drawings as well.

In some implementations, a system for electronically locking and unlocking locks of an electronic gaming machine may be provided. The system may include the electronic gaming machine having a cabinet defining an internal compartment having a first internal portion and an internal cashbox portion configured to receive a cashbox, a first door rotatably coupled to the cabinet and configured to rotate between a first closed position and a first open position, to cover a first opening of the first internal portion and prevent access to the first internal portion in the first closed position, and to provide access to the first internal portion in the first open position, a first door lock mechanism configured to be electronically actuated between a first locked position and a first unlocked position, to prevent the first door from moving out of the first closed position while in the first locked position, and to allow the first door to move out of the first closed position while in the first unlocked position, a first cashbox door rotatably coupled to the cabinet and configured to rotate between a second closed position and a second open position, to cover a cashbox opening of the internal cashbox portion and prevent access to the internal cashbox portion in the second closed position, and to provide access to the internal cashbox portion in the second open position, a cashbox door lock mechanism configured to be electronically actuated between a second locked position and a second unlocked position, to prevent the first cashbox door from moving out of the second closed position while in the second locked position, and to allow the first cashbox door to move out of the second closed position while in the second unlocked position, and a radio frequency (RF) receiver coupled to the cabinet and configured to receive wireless RF signals having data, and a controller having one or more processors and one or more memories that store instructions for controlling the first door lock mechanism and the cashbox door lock mechanism. The instructions may be configured to cause the one or more processors to receive first data from the wireless RF signals having the first data and received from a first wireless device at the RF receiver, determine whether the first data is associated with unlocking the first door and unlocking the first cashbox door, cause, in response to determining that the first data is associated with unlocking the first door and not associated with unlocking the first cashbox door, the first door lock mechanism to move into the first unlocked position and the cashbox door lock mechanism to remain in the second locked position, cause, in response to determining that the first data is associated with unlocking the first cashbox door and not associated with unlocking the first door, the cashbox door lock mechanism to move into the second unlocked position and the first door lock mechanism to remain in the first locked position, and cause, in response to determining that the first data is associated with unlocking the first door and unlocking the first cashbox door, the first door lock mechanism to move into the first unlocked position and the cashbox door lock mechanism to move into the second unlocked position.

In some embodiments, the instructions may be further configured to cause the one or more processors to receive, while the first door lock mechanism is in the first unlocked position, the first data from the wireless RF signals having the first data and received from the first wireless device at the RF receiver, cause, in response to receiving the first data while the first door lock mechanism is in the first unlocked position, the first door lock mechanism to move into the first locked position, receive, while the cashbox door lock mechanism is in the second unlocked position, the first data from the wireless RF signals having the first data and received from the first wireless device at the RF receiver, and cause, in response to receiving the first data while the cashbox door lock mechanism is in the second unlocked position, the cashbox door lock mechanism to move into the second locked position.

In some embodiments, the instructions may be further configured to cause the one or more processors to receive wireless RF signals having the first data from the first wireless device at a first time, determine whether the first data is associated with unlocking the first door and whether the first time is within a first authorized time period, determine whether the first data is associated with unlocking the first cashbox door and whether the first time is within a second authorized time period, cause, in response to determining that the first data is associated with unlocking the first door and that the first time is within the first authorized time period, the first door lock mechanism to move into the first unlocked position, cause, in response to determining that the first data is not associated with unlocking the first door or that the first time is outside the first authorized time period, the first door lock mechanism to remain in the first locked position, cause, in response to determining that the first data is associated with unlocking the cashbox door and that the first time is within the second authorized time period, the cashbox door lock mechanism to move into the second unlocked position, and cause, in response to determining that the first data is not associated with unlocking the cashbox door or that the first time is outside the second authorized time period, the cashbox door lock mechanism to remain in the second locked position.

In some embodiments, the instructions may be further configured to cause the one or more processors to receive wireless RF signals having second data from a second wireless device, determine whether the second data has been received from the second wireless device, cause, in response to determining that the second data has been received from the second wireless device, the cashbox door lock mechanism to be moved into the second unlocked position in response to receiving the first data from the first wireless device, and cause, in response to determining that the second data has not been received from the second wireless device, the cashbox door lock mechanism to remain in the second locked position in response to receiving the first data from the first wireless device.

In some such embodiments, the instructions may be further configured to cause the one or more processors to determine whether the second data has been received from the second wireless device in a second time period, cause, in response to determining that the second data has been received from the second wireless device in the second time period, the cashbox door lock mechanism to be moved into the second unlocked position in response to receiving the first data from the first wireless device, and cause, in response to determining that the second data has not been received from the second wireless device in the second time period, the cashbox door lock mechanism to remain in the second locked position in response to receiving the first data from the first wireless device.

In some such embodiments, the instructions may be further configured to cause the one or more processors to determine whether the first data has been received from the first wireless device in a first time period, cause, in response to determining that the second data has been received from the second wireless device in the second time period, the cashbox door lock mechanism to be moved into the second unlocked position in response to receiving the first data from the first wireless device in the first time period, and cause, in response to determining that the second data has not been received from the second wireless device in the second time period and/or that the first data has not been received from the first wireless device in the second time period, the cashbox door lock mechanism to remain in the second locked position in response to receiving the first data from the first wireless device.

In some such embodiments, the electronic gaming machine may further include a second cashbox door rotatably coupled to the cabinet and configured to rotate between a third closed position and a third open position, to cover a second cashbox opening of the internal cashbox portion and to prevent access to the first cashbox door and the internal cashbox portion in the third closed position, and to provide access to the first cashbox door in the third open position, and a second cashbox door lock mechanism configured to be electronically actuated between a third locked position and a third unlocked position, to prevent the second cashbox door from moving out of the third closed position while in the third locked position, and to allow the second cashbox door to move out of the third closed position while in the third unlocked position, and the instructions may be further configured to cause the one or more processors to cause, in response to determining that the second data has been received from the second wireless device, the second cashbox door lock mechanism to be moved into the third unlocked position, and cause, in response to determining that the second data has not been received from the second wireless device, the second cashbox door lock mechanism to remain in the third locked position.

In some such embodiments, the instructions may be further configured to cause the one or more processors to determine whether the second data has been received from the second wireless device in a second time period, cause, in response to determining that the second data has been received from the second wireless device in the second time period, the second cashbox door lock mechanism to be moved into the third unlocked position in response to receiving the second data from the second wireless device, and cause, in response to determining that the second data has not been received from the second wireless device in the second time period, the second cashbox door lock mechanism to remain in the third locked position in response to receiving the first data from the first wireless device.

In some embodiments, the instructions may be further configured to cause the one or more processors to receive information relating to a request for service for the electronic gaming machine, cause, in response to receiving the information relating to the request for service and receiving the first data after receiving the information, the first door lock mechanism to move into the first unlocked position and the cashbox door lock mechanism to remain in the second locked position, and cause, in response to receiving the first data without receiving the information, the first door lock mechanism to remain in the first locked position and the cashbox door lock mechanism to remain in the second locked position.

In some such embodiments, the instructions may be further configured to cause the one or more processors to determine, in response to receiving the information relating to the request for service, a set of employees that are on duty at a location of the electronic gaming machine and at a time the request for service is received, retrieve door lock access data associated with the set of employees and store the door lock access data on the one or more memories, and determine, in response to receiving the first data, whether the door lock access data indicates that the first data is associated with moving the first door lock mechanism to move into the first unlocked position, and cause, in response to receiving the first data and determining that the door lock access data indicates that the first data is associated with causing the first door lock mechanism to move into the first unlocked position, the first door lock mechanism to move into the first unlocked position.

In some embodiments, the system may further include a second controller on the electronic gaming machine and having one or more second processors and one or more second memories that store second instructions for causing a first authorization to be transmitted to the controller. The controller may be positioned in the electronic gaming machine, the first authorization may be configured to allow the receipt of the first data to cause the first door lock mechanism to move into the first unlocked position and the cashbox door lock mechanism to remain in the second locked position, and the instructions may be configured to cause the one or more second processors to receive the first authorization, cause, in response to receiving the first authorization and receiving the first data after receiving the first authorization, the first door lock mechanism to move into the first unlocked position and the cashbox door lock mechanism to remain in the second locked position, and cause, in response to receiving the first data without receiving the first authorization, the first door lock mechanism to remain in the first locked position and the cashbox door lock mechanism to remain in the second locked position.

In some embodiments, the system may further include a second controller on the electronic gaming machine and having one or more second processors and one or more second memories that store second instructions for causing a first authorization to be transmitted to the controller. The controller may be positioned in the electronic gaming machine, the first authorization may be configured to allow the receipt of the first data to cause the cashbox door lock mechanism to move into the second unlocked position and the first door lock mechanism to remain in the first locked position, and the instructions may be configured to cause the one or more processors to receive the first authorization, cause, in response to receiving the first authorization and receiving the first data after receiving the first authorization, the cashbox door lock mechanism to move into the second unlocked position and the first door lock mechanism to remain in the first locked position, and cause, in response to receiving the first data without receiving the first authorization, the first door lock mechanism to remain in the first locked position and the cashbox door lock mechanism to remain in the second locked position.

In some embodiments, the system may further include a second controller on the electronic gaming machine and having one or more second processors and one or more second memories that store second instructions for causing a first authorization to be transmitted to the controller. The controller may be positioned in the electronic gaming machine, the first authorization may be configured to change or replace a first credentials database with a second credentials database that associates the first data with unlocking the first door, and the instructions may be configured to cause the one or more processors to receive the first authorization, change or replace, in response to receiving the first authorization, the first credentials database with the second credentials database, determine whether the first data is associated with unlocking the first door in the second credentials database, and cause, in response to determining that the first data is associated with unlocking the first door in the second credentials database, the first door lock mechanism to move into the first unlocked position.

In some embodiments, determining whether the first data is associated with unlocking the first door may include comparing the first data to a credentials database having first access data indicating which data is authorized to unlock the first door, and determining whether the first data is associated with unlocking the first cashbox door may include comparing the first data to the credentials database having second access data indicating which data is authorized to unlock the first cashbox door.

In some such embodiments, the credentials database may be stored on the one or more memories and the controller may be on the electronic gaming machine.

In some embodiments, the instructions may be configured to cause the one or more processors to store, in response to receiving the first data, identification information associated with the first data, and the identification information may include a time the first data was received, a date the first data was received, an identification of a person associated with the first data, an employee categorization of the person associated with the first data, or a combination thereof.

In some embodiments, the system may further include a cashbox lock mechanism configured to be electronically actuated between a cashbox locked position and a cashbox unlocked position, configured to prevent removal of the cashbox from the electronic gaming machine in the cashbox locked position, and configured to allow removal of the cashbox from the electronic gaming machine in the cashbox unlocked position. The instructions may be further configured to cause the one or more processors to cause, in response to determining that the first data is associated with unlocking the cashbox lock mechanism, the cashbox lock mechanism to move into the cashbox unlocked position.

In some such embodiments, the system may further include a second RF receiver configured to receive RF signals having data. The instructions may be further configured to cause the one or more processors to receive first data from the wireless RF signals having the first data and received from the first wireless device at the second RF receiver, determine that the first data has been received from the first wireless device at the second RF receiver, and cause, in response to determining that the first data is associated with unlocking the cashbox lock mechanism and that the first data has been received from the first wireless device at the second RF received, the cashbox lock mechanism to move into the cashbox unlocked position.

In some such embodiments, the second RF receiver may be coupled to the cabinet or to a cashbox.

In some embodiments, the RF receiver may be configured to receive radio frequency (RF) signals comprising radio frequency identification (RFID) signals, near field communication (NFC) signals, Bluetooth signals, or a combination thereof.

Additional aspects will be set forth in the detailed description which follows, and, in part, will be apparent from the disclosure, or may be learned by practice of the disclosed embodiments and/or the claimed subject matter.

The foregoing general description and the following detailed description are illustrative and explanatory and are intended to provide further explanation of the claimed subject matter.

### BRIEF DESCRIPTION OF THE DRAWINGS

FIG. 1 is an exemplary diagram showing several EGMs networked with various gaming-related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4A depicts a system having an electronic gaming machine in accordance with disclosed implementations.

FIG. 4B depicts the electronic gaming machine of FIG. 4A in a second configuration.

FIG. 5 depicts a first technique in accordance with disclosed implementations.

FIGS. 6A-6C depict simplified block diagram sequences of the system of FIGS. 4A and 4B.

FIG. 7 depicts another technique in accordance with disclosed implementations.

FIG. 8 depicts yet another technique in accordance with disclosed implementations.

FIG. 9 depicts another technique in accordance with disclosed implementations.

FIG. 10 depicts another system in accordance with disclosed implementations.

FIG. 11 depicts yet another example technique.

FIG. 12 depicts another example technique.

The Figures are provided for the purpose of providing examples and clarity regarding various aspects of this disclosure and are not intended to be limiting.

### DETAILED DESCRIPTION

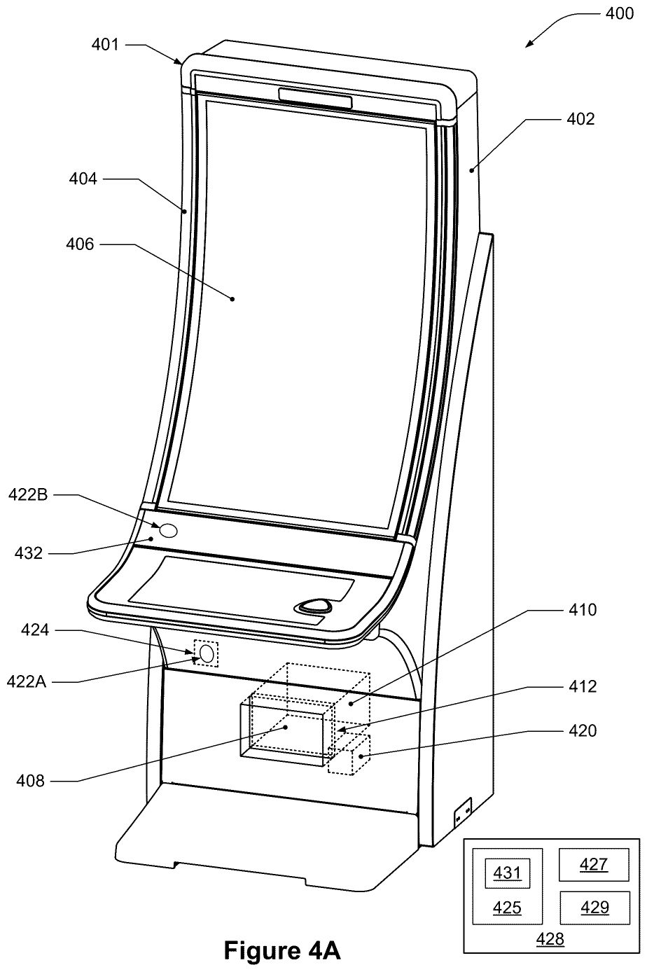

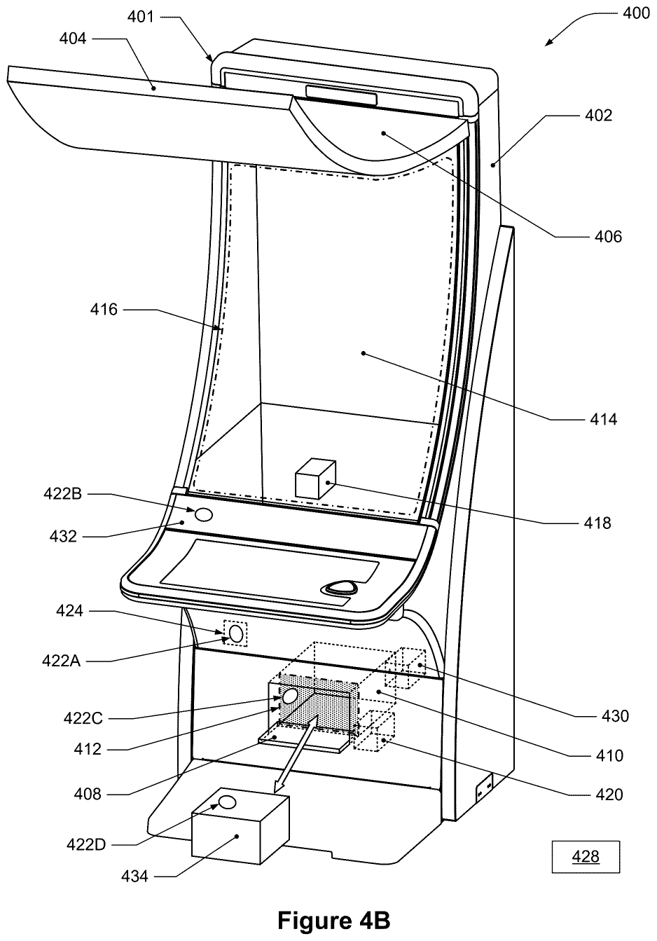

The following discussion provides overall context for electronic gaming machines, some of which may include an enclosure such as those discussed later herein starting with FIG. 4A.

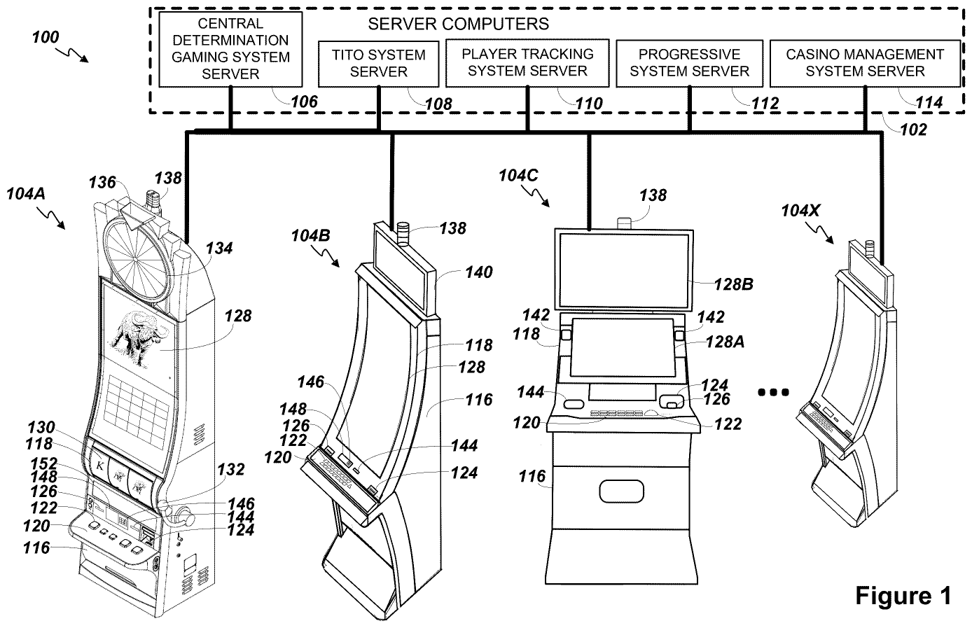

FIG. 1 illustrates several different models of EGMs which may be networked to various gaming-related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementations, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

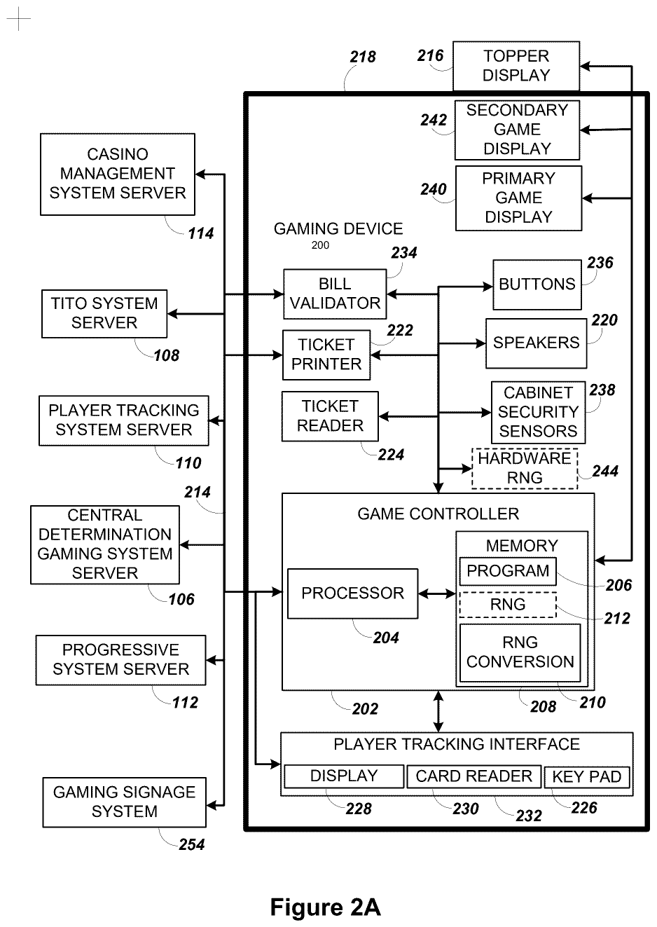

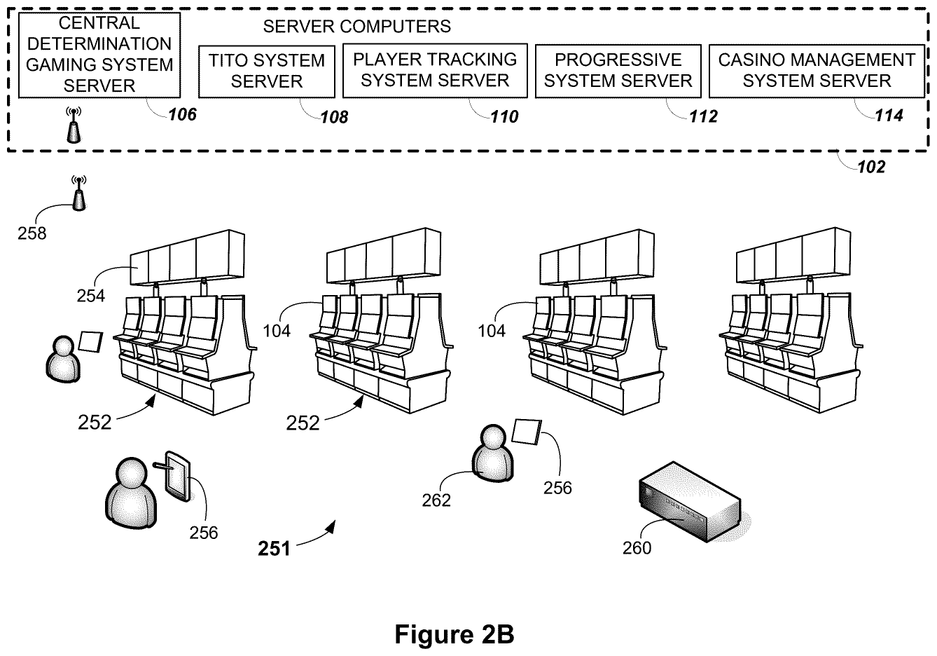

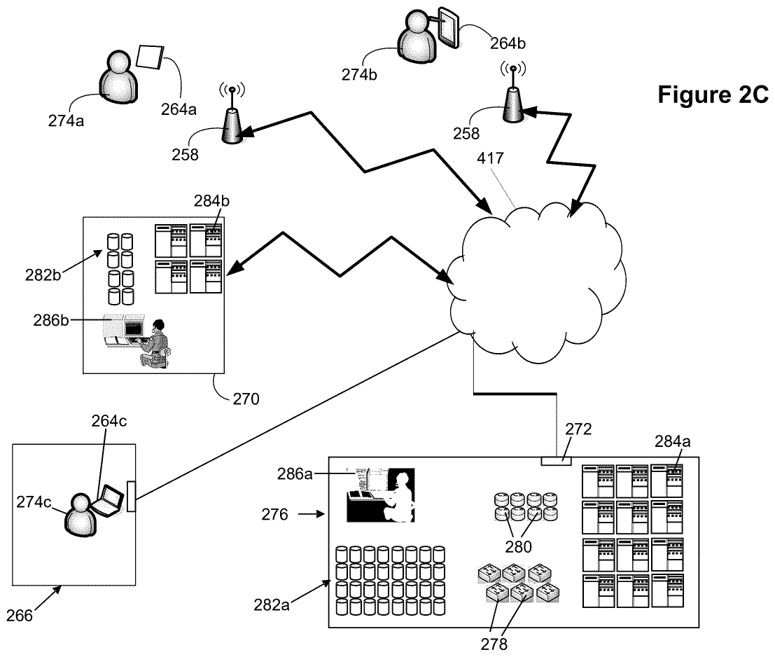

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 may, for example, be a remote gaming server (RGS) or similar system in some implementations. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286b. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

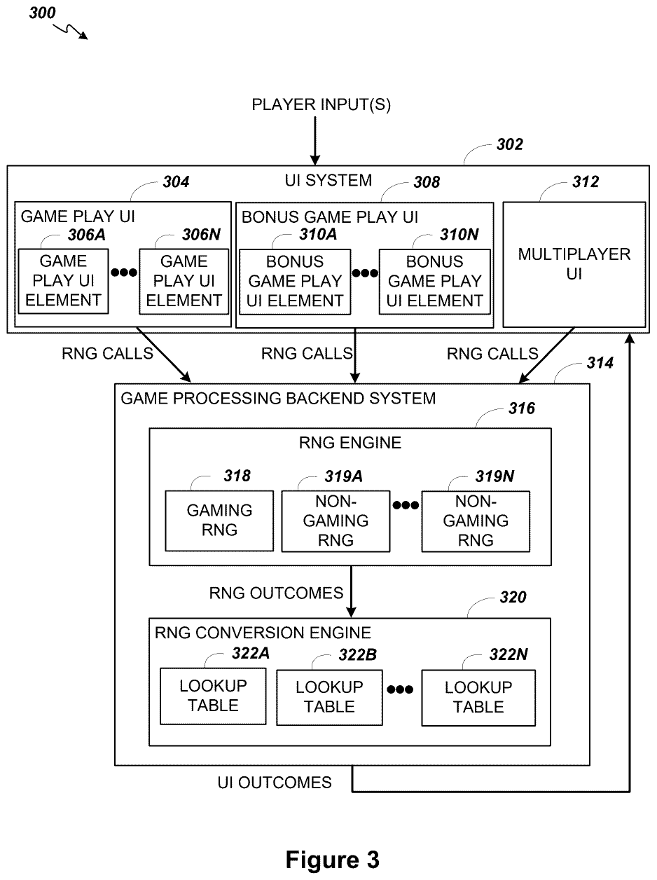

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

Electronic gaming machines (EGMs) such as those discussed above may have cabinets with access panels, doors, slide-out trays, or separate enclosures (e.g., a bill validator cage) within the cabinet. For example, an EGM may have a door and have one or more display devices and other components, such as button decks and bill validators, mounted thereto. In another example, an EGM may have a cashbox positioned within the cabinet, and this cashbox may be located behind two doors, one external cabinet door and another internal door inside the cabinet. As used herein, a cashbox may be considered a container configured to contain monetary and non-monetary currency, such as bills and redeemed cashless tickets. In yet another example, a power supply and other electronics are located within the cabinet and located behind another exterior door at another location on the EGM. It is desirable to prevent unwanted access to the internal compartments and components of an EGM and thereby lock each of its access doors. It is also desirable to selectively control access to the various internal compartments of an EGM and limit an employee's access within an EGM to only the area related to that employee's job function. For instance, a service attendant may be responsible for replacing printer paper and it may be desirable to provide that employee access to only the compartment on the EGM having the printer paper, and not to other internal compartments, such as the main game computer, power supply, or cashbox. Likewise, it may be desirable to provide access to a cashbox by attendants collecting the cashboxes and again, not to other compartments housing sensitive electronics or the displays.

Many EGMs use conventional physical key-based locks to control access to the EGM's internal compartments and such key-based locks have numerous disadvantages. For example, one EGM may have at least two, three, or four unique locks that each require a separate key. Having physical keys presents numerous challenges and complexities, such as requiring distribution, tracking, and maintenance of these keys. The use of physical keys can lead to lost or misplaced keys, as well as potential unauthorized use of such keys. For example, a key may be retained by an employee after their employment ends and the loss of the key retained by the employee may go unnoticed, or unnoticed for a period of time, which can allow the ex-employee, or others with the key, to access an EGM without authorization. Further, if there is loss or unauthorized use of a key, as plurality of EGMs may all have the same lock for one compartment, such as for the power supply compartment, which uses the same key for all the EGMs, if this one lock needs to be replaced or rekeyed because of unauthorized use, for example, then all the locks on all these EGMs must be replaced or rekeyed which costs time and money, and results in unwanted nonrevenue-generating EGM downtime.

Additionally, revoking an employee's access to a physical key-based lock on an EGM can be challenging since there may be a delay in receiving the employee's key and verifying that all keys have been received. Further, the tracking of each opening and closing of a door, as well as the identity of each person accessing the door, is not traced with conventional key-based locks. In another instance, on-the-fly or remote access cannot be given to employees with conventional key-based locks.

Provided herein are new and novel EGMs and systems for electronically locking and unlocking EGM doors. Each door of the EGM may have a corresponding lock mechanism that is configured to be unlocked through mechanical actuation by an electrically powered actuator, such as by a motor or solenoid providing linear and/or rotational movement. A controller of the EGM causes electrical signals to be sent to each actuator to unlock and lock the respective lock mechanism for each door. The EGMs are configured to electronically lock and unlock their door lock mechanisms based on receiving wireless signals, such as radio frequency identification (RFID), Bluetooth, Near Field Communication (NFC) signals, Wi-Fi signals, or a combination thereof, received at a radiofrequency (RF) receiver on the EGM. To control and restrict access to the EGM doors and corresponding compartments, some implementations use a credentials database that stores door lock access data specifying the various access levels for each door such that only persons or devices with a particular credential are able to unlock and access a particular door. When an attendant or other employee places a key card, RFID chip, or other wireless device proximate to the EGM's wireless receiver, a controller is configured to determine whether that wireless device has any credentials associated with unlocking any door of the EGM. If it is determined that the wireless device has credentials associated with unlocking an EGM door, the EGM controller is configured to cause that door's door lock mechanism to move into an unlocked position. In some instances, the EGM is also configured to lock the lock mechanism in response to the wireless device being placed proximate to the wireless receiver another time. In some implementations, both unlocking and locking may be restricted to the credentials as provided herein. In other implementations, locking may be less restricted such that received signals associated with a broader database may be configured to cause a door to be locked. For instance, any employee in the credentials database may be able to lock a door while the unlocking is more restricted to various locations of the EGM.

For example, a service technician responsible for repairing a display may need access to a door providing access to the display components, and not to a cashbox door providing access to the cashbox. The credentials database stores door lock access data having data indicating which received data, such as the data from a wireless device of the service technician like an RFID badge, has access to opening the door. When this service technician scans the RFID badge on the wireless receiver of the EGM, the data received from the RFID badge is compared with, or otherwise analyzed with respect to, the credentials database. A determination may be made as to which doors are associated with being unlocked by the data received from the RFID badge. In this example, the door lock access data in the credentials database may indicate that the data from the RFID tag has access to the display door and not the cashbox door. In response to this determination, the door lock mechanism for the display door may be electronically unlocked while the door lock mechanism for the cashbox door remains locked.

In a more specific example, the data received from the RFID badge may be a particular hexadecimal code (“hex code”) and the credentials database stores a plurality of hex codes in one or more locations indicating which door lock may be locked or unlocked. Upon receiving the data from the RFID badge, a determination may be made whether that received hex code is located within the credentials database. If it is, then a determination may be made as to which door or doors are associated with the received hex code and resulting instructions are sent to the EGM controller to cause the door locks associated with those doors to unlock. For doors or locks not associated with that received hex code, they may remain locked. In some instances, in response to determining that a hex code is within a location in the credentials database, an instruction is sent which causes the door lock mechanism associated with that hex code to be moved into an unlocked position. In some cases, the hex code may be associated with one or more door lock mechanisms and one or more user IDs, and such hex codes may be preconfigured, dynamically configured, or both.

The cabinet of an EGM is generally configured with RF shielding to prevent, or reduce, wireless signals from exiting and entering the EGM cabinet. It may be advantageous to reduce and prevent RF signals from entering the EGM and causing the EGM to malfunction, become damaged, cause the EGM to dispense money, or provide access to the cashbox. It may also be advantageous to prevent and reduce RF signals from exiting the EGM to provide safety to players around the EGM and prevent wireless interference with other devices, such as other EGMs, radios, mobile devices, or the like. Because of this, it is generally challenging to provide a wireless receiver for an EGM. As provided herein, the EGM described below is configured to provide a wireless receiver in various manners, such as in a portion of the button deck, in a portion of the player tracking unit, as well as in a location on the cabinet with little to no RF shielding.

The systems described herein provide technical solutions to numerous technical problems. One technical problem is how to provide wireless and electronic control of locks to EGMs. Another technical problem is how to control access to different compartments of the EGM to different personnel, including how to grant and prevent access without physically changing or replacing the locks. Yet another technical problem is how to dynamically adjust access to multiple doors of the EGM, such as on-the-fly granting or revoking of access to one or more compartments. This may include how to grant access based on a service request of the EGM to personnel on-duty at the location of the EGM. Yet another technical problem is how to provide variable wireless access to different compartments of the EGMs on a time-based manner, such as access at a particular time of day and/or for a particular length of time, such as access to a cashbox in the middle of the night for a limited time. Another technical problem is how to provide multi-level or multi-layer access, such as requiring one employee, like a manager, to scan or swipe the wireless receiver of the EGM before another employee, like an attendant, scans or swipes the wireless receiver of the EGM and accesses a door of the EGM, like the cashbox door. Yet another technical problem is how to lock or track the opening and closing of the doors on the EGM. Another technical problem is how to provide an electronically controllable lock mechanism for the cashbox and control wireless access to the unlocking and removal of the cashbox.

Numerous technical solutions to these technical problems are provided by the systems herein. For example, the systems are configured to store access data on a credentials database and when wireless data is received, determine whether that wireless data is associated with unlocking one or more of the doors on the EGM. If this wireless data is associated with unlocking one or more of the doors on the EGM, then the system is configured to electronically unlock only the door or doors to which the wireless data has access. The systems may be configured to only provide access to the door or doors as provided in the credentials database. The systems may also be configured to provide access to a particular door or doors without a credentials database in certain scenarios. Further, the systems are configured to provide time-based windows for accessing the doors, such as unlocking a door if the wireless data is received within an authorized window and not unlocking the door if the wireless data is received outside the authorized window. The systems can also change access based on various events, such as receiving a service request for an EGM. In response to receiving the service request, access can be granted by allowing particular wireless data, such as by particular employees on duty at the time of the request, to open the door. In some instances, the credentials database may be updated, changed, or replaced to grant or restrict access on-the-fly and remotely. Another technical solution is that the systems are able to electronically lock the EGM doors in response to receiving the wireless data, such as providing an RFID tag to the EGM's RF receiver.

In another example solution, the systems can require the receipt of wireless data from one employee, such as the manager, before allowing another employee to scan or swipe the EGM and open a door. This provides multilayer and multilevel security for accessing EGM doors. In a related example, the systems can require the receipt of a first wireless data from one employee, such as the manager, to unlock an outer door that blocks access to an inner door. After that employee has unlocked the outer door, then another employee is required to provide a second wireless data, after which the inner door may be unlocked. This again provides multilayer security. Further, the credentials database may be changed or updated to add, remove, or change access by various personnel. Another technical solution is storing the information associated with the wireless data received for locking or unlocking the doors, such as an employee's name, job function, and time and date of the access. The systems also provide the ability to electronically lock and unlock the cashbox itself based on received wireless signals, like an RFID card swipe of the EGM's wireless receiver, as well as log information associated with the person accessing the cashbox.

Various aspects of systems and EGMs will now be discussed. FIG. 4A depicts a system having an electronic gaming machine in accordance with disclosed implementations. The system 400 has an electronic gaming machine (EGM) 401 with a cabinet 402 defining an internal compartment (not visible here) which may be considered an area inside of the cabinet 402. The cabinet 402 also has a first door 404 rotatably connected to the cabinet 402 and a main display 406 connected to, or mounted on, the first door 404. The first door 404 is configured to be moved between a first closed position and a first open position, such as by rotating about a rotation axis. The first door 404 may open outwards, such as upwards or sideways with respect to the floor on which the EGM 401 is directly or indirectly positioned. The cabinet 402 also includes a first cashbox door 408 positioned inside the EGM internal compartment, rotatably connected to a frame of the cabinet 402, and configured to be moved between a second open position and a second closed position.

The cabinet 402 defines a first opening (not visible in FIG. 4A) which provides access into a first internal portion of the internal compartment and defines a cashbox opening 412 which provides access into an internal cashbox portion 410 configured to hold a cashbox inside the internal compartment. The first door 404 is configured to cover the first opening when in the first closed position and the first cashbox door 408 is configured to cover the cashbox opening 412 when in the second closed position. During normal operations, as illustrated in FIG. 4A, the first door 404 and the first cashbox door 408 are in the first and second closed positions, respectively, thereby preventing access into the internal compartment. During other operations, like maintenance, service, or component removal like the cashbox, the first door 404 and the first cashbox door 408 may be opened.

FIG. 4B depicts the electronic gaming machine of FIG. 4A in a second configuration. Here, the first door 404 is in a first open position thereby allowing access into the internal portion 414 through the first opening 416 identified with a dash-dot-dash boundary line. As can be seen, the first door 404 may be rotated outwards and upwards. The first cashbox door 408 is also in a second open position thereby allowing access into the internal cashbox portion 410, where a cashbox may be located, through the cashbox opening 412. The cashbox opening 412 is also highlighted with a dash-dot-dash boundary line.

The EGM 401 also has a first door lock mechanism 418 configured to be electronically actuated between a first locked position and a first unlocked position. The first door lock mechanism 418 is positioned inside the internal compartment of the cabinet 402 and in FIG. 4B, the first door lock mechanism 418 is representationally illustrated by a box inside the internal compartment of the cabinet 402. As discussed below, the first door lock mechanism 418 may be positioned in various locations within the cabinet 402. When in the first locked position, the first door lock mechanism 418 is configured to prevent the first door 404 from moving from the first closed position, illustrated in FIG. 4A, to an open position, like illustrated in FIG. 4B. When in the first unlocked position, the first door lock mechanism 418 is configured to allow the first door 404 to move from the first closed position, illustrated in FIG. 4A, to an open position, like illustrated in FIG. 4B.

The first door lock mechanism 418 may have various configurations that allow it to be electronically actuated to prevent and allow movement of the first door 404. For example, the first door lock mechanism may have a tongue and electronic rotational actuator with a motor configured to rotate the tongue, or latch, about an axis. The tongue of the first door lock mechanism may be coupled to the cabinet and configured to rotate and be positioned inside a hole feature, sometimes called a mortise, on the first door. When the tongue is positioned inside the mortise of the door, the door is prevented from movement, and this positioning may be considered a first lock position of the first door lock mechanism. When the tongue, or latch, is rotated by the electronic rotational actuator out of the first door, the tongue does not prevent or block movement of the first door, and the first door may be moved.

In another example, the first door may be opened using a door latch mechanism that involves linear actuation with a linear pull member. The first door lock mechanism may be configured to block the movement of the linear pull member and thereby prevent the door latch mechanism from releasing the first door from the cabinet. The first door lock mechanism may again have a rotational latch, or tongue, that is configured to be rotated by the electronic rotational actuator and engage with, or be positioned inside, a feature on the linear pull member, such as a hole or notch. When this rotational latch is engaged with this hole or notch on the linear pull member, the linear pull member is prevented from moving, or moving fully, to disengage the latch mechanism and allow the first door to move. In some instances, the first door lock mechanism may also have a bolt and an electronic actuator configured to move the bolt linearly, such as a linear actuator or rotational actuator. The bolt may be moved linearly to engage with the feature on the linear pull member and prevent its movement, thereby preventing the first door latch mechanism from disengaging allowing the first door to move.

These are non-limiting examples and other electronically controllable lock mechanisms are contemplated here. Regardless of the configuration of the first lock mechanism, it is configured to prevent the first door from moving out of the first closed position while in the first locked position, and to allow the first door to move out of the first closed position while in the first unlocked position. Further, the first lock mechanism is configured to be moved with electronically controlled actuation.

The EGM 401 also has a cashbox door lock mechanism 420 configured to be electronically actuated between a second locked position and a second unlocked position. The cashbox door lock mechanism 420 is positioned inside the internal compartment of the cabinet 402 and in FIG. 4B, the cashbox door lock mechanism 420 is representationally illustrated by a box inside the internal compartment of the cabinet 402 and adjacent to the first cashbox door 408. The cashbox door lock mechanism 420 may be positioned in various locations within the cabinet 402 near the first cashbox door 408 in order to engage with the first cashbox door 408. When in the second locked position, the cashbox door lock mechanism 420 is configured to prevent the first cashbox door 408 from moving from the second closed position, illustrated in FIG. 4A, to an open position, like illustrated in FIG. 4B. When in the second unlocked position, the cashbox door lock mechanism 420 is configured to allow the first cashbox door 408 to move from the second closed position, illustrated in FIG. 4A, to an open position, like illustrated in FIG. 4B.

The cashbox door lock mechanism 420 may be configured in various ways, such as like the first door lock mechanism described herein. In some implementations, the cashbox door lock mechanism 420 may have a linearly actuated bolt that is configured to be moved from a locked position to an unlocked position by an electronically powered actuator. The lock mechanism may also be configured to be moved by an elastic member coupled to the bolt into a position where it is ready to automatically engage with the first cashbox door when the first cashbox door is closed. The electronically powered actuator may be configured to move the bolt in a first direction along a linear axis and cause the bolt to disengage from the first cashbox door. In some instances, the actuator may be configured to retain the bolt in this unlocked position. Once the first cashbox door is opened, the elastic member, like a spring, may be configured to cause the bolt to move in a second direction opposite the first direction along the linear axis. This position may be considered the ready to engage position. When the first cashbox door is closed, the door is configured to contact the bolt and move the bolt in the first direction after which the bolt is configured to be moved by the elastic member in the second direction and engage with a strike plate, hole, or other portion of the first cashbox door to lock the door and prevent its movement.

The electronic gaming machine 401 also has a radio frequency (RF) receiver coupled to the cabinet 402 and configured to receive RF signals having data. As provided herein, the EGM cabinet 402 is configured to act as a Faraday cage to prevent and reduce wireless signals from passing into and out of the cabinet 402. As such, it can be challenging to provide an RF receiver inside the cabinet 402 in a location where RF signals may be received. Here, an RF receiver 422A may be positioned inside the cabinet 402 at a new position 424 that has limited or no RF interference or blocking. The RF receiver 422B may also be positioned within the player tracking interface 432 (described above) and/or within or beneath the button deck which is a location on the EGM outside of the RF shielding/Faraday cage of the cabinet 402. The RF receiver and/or an RF antenna may also be positioned in other locations outside the cabinet 402, such as on a side, and hardwired to a power source and a controller inside the cabinet 402. Wherever the RF receiver is positioned it is configured to receive power and to be in communication with a controller 428 of the system 400.

The RF receiver is configured to receive various RF signals, such as such as radio frequency identification (RFID), Bluetooth, Near Field Communication (NFC) signals, Wi-Fi signals, or a combination thereof. The RF receiver may be an RF transceiver and also be configured to emit RF signals. For example, an employee badge, tag, or other device may have an RFID tag positioned therein that is a passive RFID tag which is configured to receive RF signals from the RF receiver and thereby power an internal chip of the passive RFID tag and transmit its own data back to the RF receiver. In some instances, the RF receiver may be considered an RF reader. In another example, the wireless device may be configured to emit its own signals which the RF receiver is configured to receive.

The system also has a controller 428 like described above. For example, the controller 428 may include one or more memory devices 425, one or more mass storage devices 427, and one or more processors 429. Each processor 429 may include a central processing unit (CPU) or computer, analog, and/or digital input/output connections, stepper motor controller boards, etc. The controller 428 is configured to control various aspects of the EGM 401, including controlling the first door lock mechanism 418 and the cashbox door lock mechanism 420. This control may include the controller 428 being communicatively coupled with the first door lock mechanism 418 and the cashbox door lock mechanism 420, and configured to cause electric signals to be transmitted to the first door lock mechanism 418 and the cashbox door lock mechanism 420 and thereby cause the first door lock mechanism 418 and the cashbox door lock mechanism 420 to move between their respective locked and unlocked positions. The controller 428 is also communicatively coupled with the RF receiver, such as RF receivers 422A and 422B, and configured to receive the data that is wirelessly transmitted to the RF receiver. In some instances, the controller 428 may be a part of the EGM 401, such as positioned inside the cabinet 402 of the EGM 401. In some other instances, the controller may be separate from the EGM 401, such as on a remote or cloud device.

As provided herein, the system 400 is configured to control and provide access to the internal portions of the EGM 401 based on access credentials for various personnel attempting access. This control includes automatically determining which, if any, doors on the EGM an employee has access to, and providing access after receiving a wireless transmission from an employee's wireless device by unlocking a door lock mechanism for the authorized door or doors. For example, an employee provides a wireless signal to the RF receiver 422B and this wireless signal has data contained therein. This received wireless data is transmitted to the controller 428 and used by the controller 428 to determine, based in some instances on a credentials database, whether that received data is associated with accessing the first door 404, the first cashbox door 408, or both. This association may include comparing the received data with data in the credentials database that sets forth to which door that received data has access. As shown in FIG. 4A, the credentials database 431 may be stored on the one or more memories 425 of the controller 428. If it is determined that the employee has access to the first door 404 or the first cashbox door 408, the controller is configured to cause the electrical actuator of the respective lock mechanism to cause the lock mechanism to move into an unlock position.

In some instances, the controller is configured to automatically or electronically lock the lock mechanisms. This may include causing a door lock mechanism to move into a locked position in response to receiving a second wireless transmission from an employee's wireless device, such as the RFID tag being positioned proximate to the RF receiver 422A.

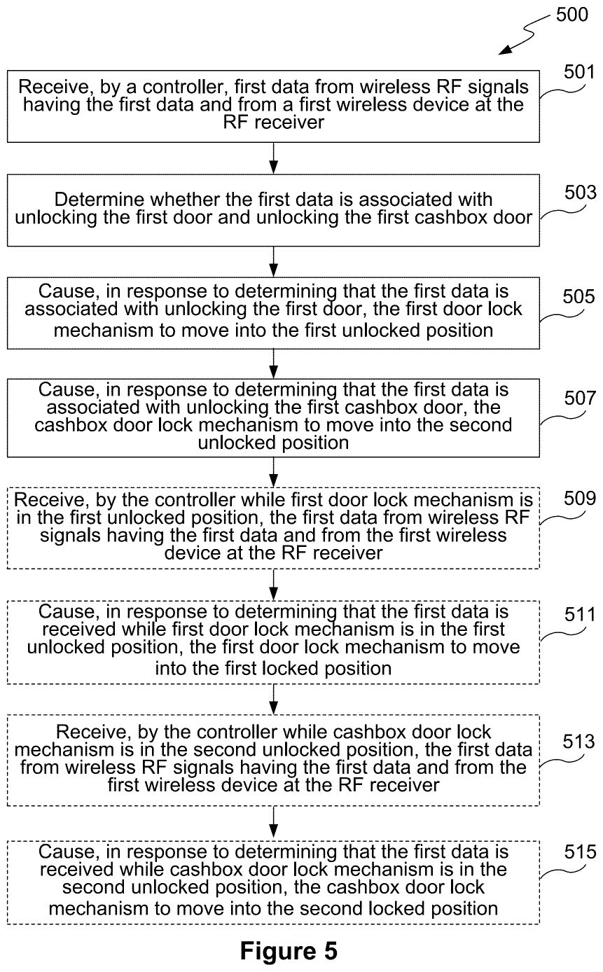

Additional functionality of the EGMs and systems will now be discussed. FIG. 5 depicts a first technique in accordance with disclosed implementations. Here, reference is made to the system 400 of FIGS. 4A and 4B. This first technique 500 includes block 501 in which the controller 428 receives first data from wireless RF signals having the first data and received from a first wireless device at one of the RF receivers 422A or 422B. As provided herein, the first wireless device transmits, or emits, wireless RF signals containing the first data. The first wireless device may be a passive device without its own internal power source, like a passive RFID tag, or an active device with its own internal power source, like an active RFID tag. Once received by the RF receivers 422A or 422B, the first data is transmitted to, and received by, the controller 428.

In block 503, once the first data has been received by the controller 428, the controller determines whether the first data is associated with unlocking the first door 404 and unlocking the first cashbox door 408. This determination may take various forms and involve multiple steps. In some implementations, a credentials database stores access data that is associated with both the first door 404 and the first cashbox door 408, and used to provide access to either or both doors. In a simple instance, the access data for the first door 404 may include a plurality of first access data, such as hexadecimal strings of data. To determine whether the first data is associated with unlocking the first door 404, the first data may be compared with the first access data, such as attempting to find the first data in the first access data or find a portion of the first data in the first access data. If the first data is found in the first access data, then the first data may be considered associated with authorization to unlock the first door. Similarly, the access data for the first cashbox door 408 may include a plurality of second access data, such as second hexadecimal strings of data. To determine whether the first data is associated with unlocking the first cashbox door 408, the first data may be compared with the second access data, such as attempting to find the first data, or a portion of the first data, in the second access data. If the first data is found in the second access data, then the first data may be considered associated with authorization to unlock the first cashbox door.

Further, if the first data is found in the first access data, then one or more commands may be issued to cause the first door 404 to be unlocked. The controller 428 may be configured to store instructions for causing the processor to make this determination and then to cause the first lock mechanism to move into the first unlocked position and thereby allow the first door 404 to be opened, as indicated by block 505. Likewise, if the first data is found in the second access data, then one or more commands may be issued to cause the first cashbox door 408 to be unlocked. The controller 428 may be configured to store instructions for causing the processor to make this determination and then to cause the cashbox door lock mechanism to move into the second unlocked position and thereby allow the first cashbox door 408 to be opened, as provided in block 507.

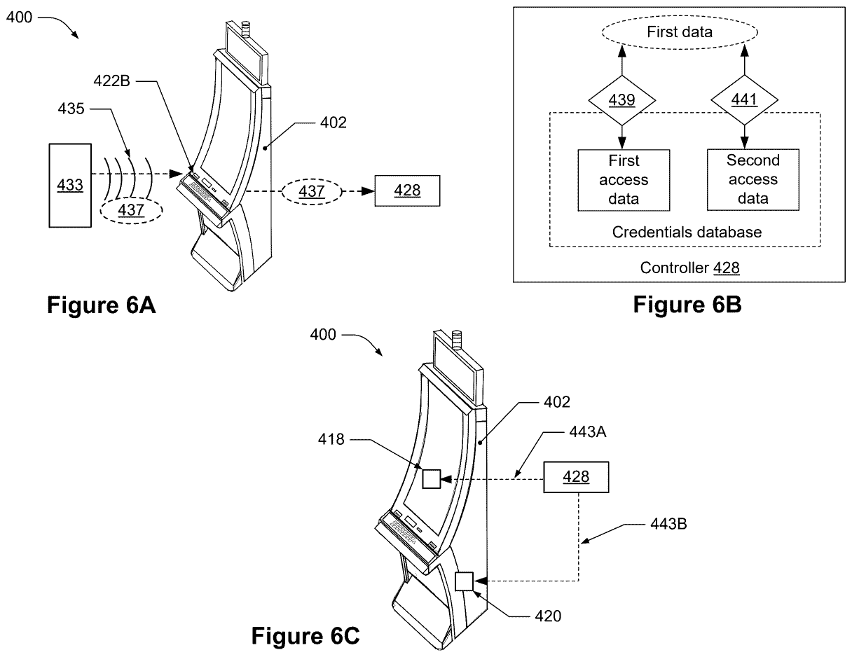

The execution of some aspects of technique 500 is illustrated in FIGS. 6A-6C which depict simplified block diagram sequences of the system of FIGS. 4A and 4B. In FIG. 6A, block 501 is illustrated in which the first wireless device 433 provides the wireless RF signals 435 having the first data 437 to an RF receiver 422B of the EGM 401, and this first data 437 is provided to the controller 428. In some instances, the controller 428 is a part of the EGM 401 while in other instances, the controller 428 may be a part of a remote controller that is separate from the EGM 401. In FIG. 6B, the controller 428 is illustrated and it determines whether the first data is associated with unlocking the first door and unlocking the first cashbox door. This may include a decision 439 which compares whether the first data is associated with the first access data in the credentials database stored on the controller 428, and a decision 441 which compares whether the first data is associated with the second access data in the credentials database. As provided herein, this first access data may be associated with, and indicate, access to the first door and unlocking the first door lock mechanism. The second access data may be associated with, and indicate, access to the first cashbox door and unlocking the cashbox door lock mechanism.

FIG. 6C depicts blocks 505 and 507 in which door lock mechanisms are unlocked. If it is determined that the first data is associated with the first access data in the credentials database, then in response to this determination, the controller 428 is configured to cause the first door lock mechanism 418 to move into the first unlocked position. FIG. 6C indicates signals 443A being transmitted from the controller 428 to the first door lock mechanism 418 which may be electrical signals directly from the controller 428, or indirectly from the controller 428 to another controller. If it is determined that the first data is associated with the second access data in the credentials database, then in response to this determination, the controller 428 is configured to cause the cashbox door lock mechanism 420 to move into the second unlocked position. FIG. 6C indicates signals 443B being transmitted from the controller 428 to the cashbox door lock mechanism 420 which may be electrical signals directly from the controller 428, or indirectly from the controller 428 to another controller.

In some implementations, the system 400 may also be configured to lock the first door 404 and first cashbox door 408. This configuration may include causing the first door lock mechanism 418 to move to the first locked position or the cashbox door lock mechanism 420 to move to the second locked position after a period of time has elapsed after unlocking these mechanisms. This may include starting a timer after causing the first door lock mechanism 418 to move to the first unlocked position or the cashbox door lock mechanism 420 to move to the second unlocked position, and determining whether the timer has reached or exceeded a particular end time. If so, then the controller 428 may cause the first door lock mechanism 418 or the cashbox door lock mechanism 420 to move into their locked positions.

In other instances, the system may be configured to lock the first door and first cashbox door in response to another receipt of the first data. Referring back to technique 500 of FIG. 5, optional block 509 provides that the controller 428 may receive the first data from the first wireless device while the first door is unlocked, such as when the first door lock mechanism is in the first unlocked position. In optional block 511, in response to receiving the first data with the first door lock mechanism 418 in the first unlocked position, the controller 428 is configured to cause the first door 404 to be locked by causing the first door lock mechanism 418 to move into the first locked position. In some implementations, a determination may be made as to the state of the first door lock mechanism 418, e.g., in the first locked position or the first unlocked position, when the first data is received. If it is determined that first door lock mechanism 418 is in the first locked position, then blocks 503 and 505 may be performed as described above. If it is determined that first door lock mechanism 418 is in the first unlocked position, then block 511 may be performed in which the first door 404 is locked. In some instances, to prevent unauthorized locking of a door, the determination of block 503 may be performed if it is determined that first lock mechanism is in the first unlocked position before locking the first door.

Similarly, optional block 513 provides that the controller 428 may receive the first data from the first wireless device while the first cashbox door 408 is unlocked, such as when the cashbox door lock mechanism 420 is in the second unlocked position. In optional block 515, in response to receiving the first data with the cashbox door lock mechanism 420 in the second unlocked position, the controller 428 is configured to cause the first cashbox door 408 to be locked by causing the cashbox door lock mechanism 420 to move into the second locked position. In some implementations, a determination may be made as to the state of the cashbox door lock mechanism 420, e.g., in the second locked position or the second unlocked position, when the first data is received. If it is determined that cashbox door lock mechanism 420 is in the second locked position, then blocks 503 and 507 may be performed like described above. If it is determined that cashbox door lock mechanism 420 is in the second unlocked position, then block 513 may be performed in which the first cashbox door 408 is locked. In some instances, to prevent unauthorized locking of a door, the determination of block 503 may be performed if it is determined that cashbox door lock mechanism 420 is in the second unlocked position before locking the first cashbox door 408.

In one example of the optional blocks of technique 500, after an employee has provided the first wireless signal to the RF reader and a door has been unlocked, the employee may again provide the first wireless signal to the RF reader and in response to this, the door may be locked. In a further example, the employee may place an RFID tag near the first RF receiver 422A which provides the first data to the system 400. In response to receiving this first data, the controller may unlock the first door 404 by causing the first door lock mechanism 418 to move to the first unlocked position. Once the employee is ready to lock the first door 404, the employee may again place the RFID tag near the first RF receiver 422A which provides the first data to the system 400. In response to receiving this first data when the first door lock mechanism 418 is in the first unlocked position, the controller 428 is configured to cause the first door lock mechanism 418 to move to the first locked position and thereby lock the first door 404.

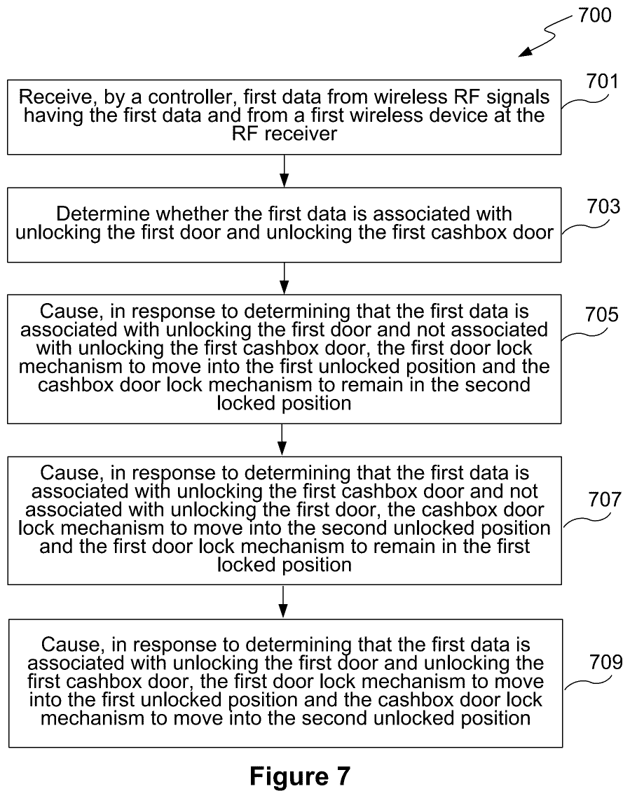

In some implementations, a wireless device may be authorized to access one EGM door, and not another EGM door, and the systems herein are configured to provide such restricted access. FIG. 7 depicts another technique in accordance with disclosed implementations. Reference is made again to the system 400 of FIGS. 4A and 4B. This technique 700 includes blocks 701 and 703 which may be the same as blocks 501 and 503 provided above. For brevity, blocks 501 and 503 are not discussed again although their concepts apply equally to blocks 701 and 703. In some instances, an employee or worker having the wireless device may be authorized to access the first door 404 and not first cashbox door 408. This authorization may be specified in the credentials database. For example, referring to the credentials database above, the first data of the first wireless device may be stored in the first access data of the credentials database which indicates the first data is authorized to unlock the first door 404. However, the first data may not be stored in the second access data of the credentials database, thereby indicating that the first data is not authorized to unlock the first cashbox door 408.

The results of block 703 may be the determination that the first data is associated with unlocking the first door 404, such as being listed in the first access data of the credentials database, and that the first data is not associated with unlocking the first cashbox door 408. Based on this determination, the first door lock mechanism 418 for the first door 404 may be unlocked while the cashbox door lock mechanism 420 remains locked. This is described in block 705 which provides that the controller is configured to cause, in response to determining that the first data is associated with unlocking the first door and determining that the first data is not associated with unlocking the first cashbox door, the first door lock mechanism 418 to move into the first unlocked position and the cashbox door lock mechanism 420 to remain in the second locked position. This block thereby advantageously provides limited, or partial, access to the EGM doors. For example, an employee performing maintenance on the display 406 is allowed access to open the first door 404 and prevented from accessing other areas of the EGM 401 like the internal cashbox portion 410.

In some instances, the results of block 703 may be the determination that the first data is associated with unlocking the first cashbox door 408, such as being listed in the second access data of the credentials database, and determining that the first data is not associated with unlocking the first door 404. Based on this determination, the cashbox door lock mechanism 420 for the first cashbox door 408 may be unlocked while the first door lock mechanism 418 remains locked. This is described in block 707 which provides that the controller is configured to cause, in response to determining that the first data is associated with unlocking the first cashbox door and not associated with unlocking the first door, the cashbox door lock mechanism to move into the second unlocked position and the first door lock mechanism to remain in the first locked position. This block thereby advantageously provides limited, or partial, access to the EGM doors. For example, an employee performing a switch of the cashbox is prevented from accessing other areas of the EGM, like the internal portion 414.

In yet some other instances, the results of block 703 may be the determination that the first data is associated with unlocking both the first door 404 and the first cashbox door 408, such as being listed in the first access data and the second access data of the credentials database. Based on this determination, the first door lock mechanism 418 for the first door 404 and the cashbox door lock mechanism 420 for the first cashbox door 408 may both be unlocked. This is described in block 709 which provides that the controller is configured to cause, in response to determining that the first data is associated with unlocking the first door and unlocking the first cashbox door, the first door lock mechanism to move into the first unlocked position and the cashbox door lock mechanism to move into the second unlocked position. This block thereby advantageously provides full access to the EGM doors, such as by a high-level employee or service technician preforming service on multiple internal areas.

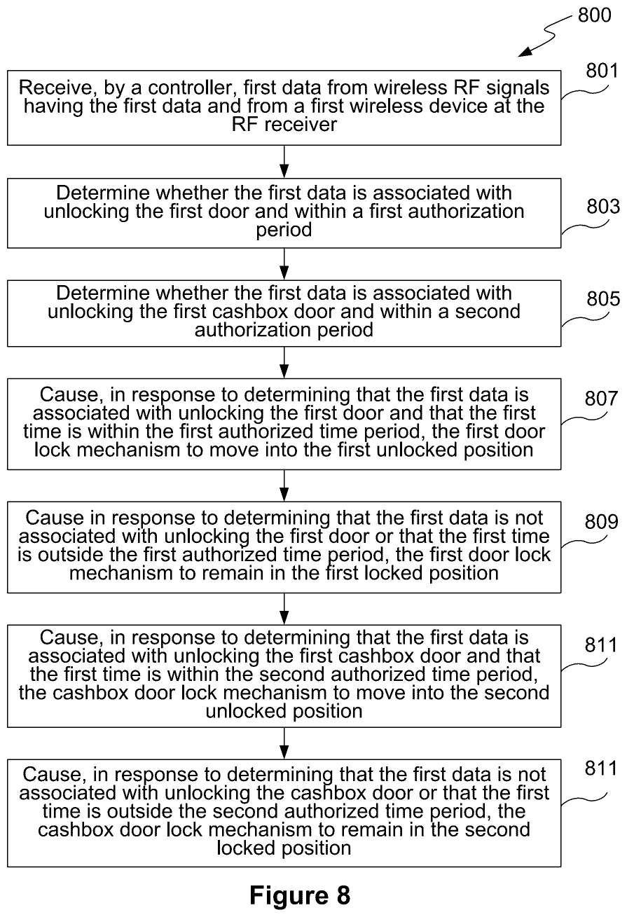

In some implementations, it may be advantageous to provide time-based authorizations to doors, such as access at a particular time, for a particular duration, or both. This can limit unauthorized access as well as reduce the time such doors may be opened. In one example, it may be advantageous to provide access to the cashbox for a small window of time in the middle of the night which can reduce the risks of cashboxes being stolen or cashbox doors being opened. Accordingly the systems provided herein are configured to store access data having time based authorization periods and cause doors to be unlocked if the first data is received from the wireless device within an authorized time and to remain locked if the first data is received outside the authorized time. FIG. 8 provides yet another technique in accordance with disclosed implementations. Reference is made to the system 400 of FIGS. 4A and 4B.

In block 801, similar to block 501, the first data is received from the first wireless device at a first time. This first time may be data stored or associated with the first data. In block 803, a determination is made as to whether the first data is associated with unlocking the first door during a first authorized time period. Similar to described above, this determination may include determining whether the first data is associated with the first access data, and determining whether the first time is associated with the first authorized time period. The credentials database may store authorization time data which specifies a range of times, and a comparison may be made as to whether the first time is within or outside the stored authorization time data. In some instances, the first access data for the first door may be associated with first authorization time data and a first check may be made to determine if the first data, or a portion thereof, is in the first access data. If it is, then a second check may be made to determine if the first time, or a portion thereof, is in the first authorization time data. If it is, then access may be granted to the first door. If either of these determinations are “no”, then the first door may remain locked. In some implementations, these checks may be reversed such that the time check occurs before the credentials database check.

Similarly in block 805, a determination is made as to whether the first data is associated with unlocking the first cashbox door during a second authorized time period. This may include determining whether the first data is associated with the second access data, and determining whether the first time is associated with the second authorized time period. In some instances, the second access data for the first cashbox door may be associated with second authorization time data and a first check may be made to determine if the first data, or a portion thereof, is in the second access data. If it is, then a second check may be made to determine if the first time, or a portion thereof, is in the second authorization time data. If it is, then access may be granted to the first cashbox door. If either of these determinations are “no”, then the first cashbox door may remain locked. Like above, in some implementations these checks may be reversed such that the time check occurs before the credentials database check.

In block 807, the first door lock mechanism may be moved into the first unlocked position in response to determining that the first data is associated with unlocking the first door and that the first time is within the first authorized time period. Again, the controller is configured to make such determinations and cause the movement of the first lock mechanism. If the first data is not associated with unlocking the first door or not within the first time period, then the first door lock mechanism remains in the first locked position. In Block 809, the first door lock mechanism remains in the first locked position in response to determining that the first data is not associated with unlocking the first door or that the first time is outside the first authorized time period.

Similarly, in block 811, the cashbox door lock mechanism may be moved into the second unlocked position in response to determining that the first data is associated with unlocking the first cashbox door and that the first time is within the second authorized time period. If the first data is not associated with unlocking the first cashbox door or not within the second authorized time period, then the cashbox door lock mechanism remains in the second locked position, as provided in block 813.

In some implementations, receipt of wireless RF signals from a second device may be required before unlocking a door in response to receiving the first data. For example, a second employee may provide second wireless signals from a second device to authorize the first device of a first employee to unlock a door, but only after the second wireless signals have been provided to the EGM. The second employee may have an RFID tag that is placed near an RF receiver 422A which transmits second wireless signals having second data. Upon receiving this second data, the system is configured to remain locked until the first employee provides an RFID tag to the RF receiver 422A and transmits the first data, which thereby causes the controller to unlock one or both of its door lock mechanisms. If the first employee provides the RFID tag with the first data to the receiver 422A before the second employee has provided the second wireless signals to the receiver 422A, the door lock mechanism remains in the locked position.

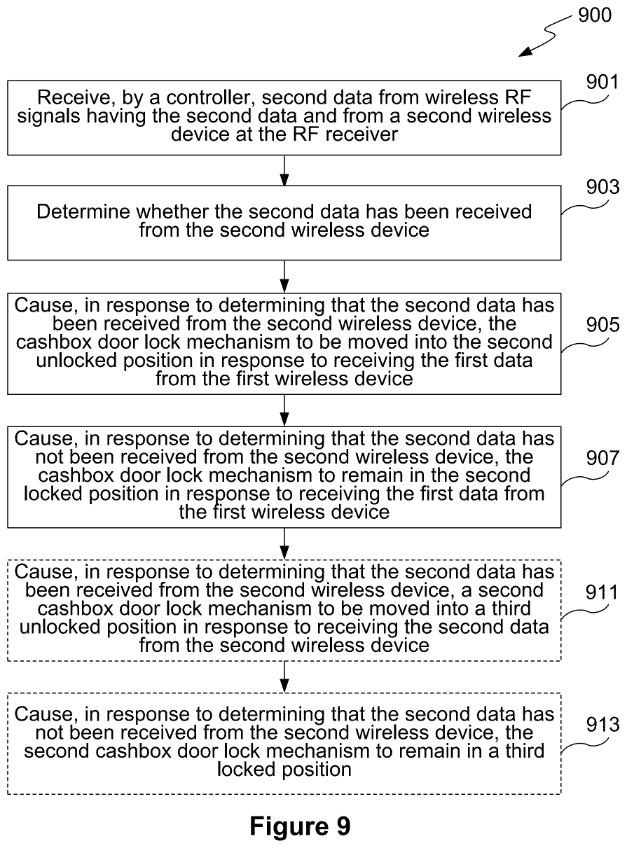

FIG. 9 provides another technique in accordance with disclosed implementations. Reference is made to the system 400 of FIGS. 4A and 4B. Here in technique 900, the system is configured to receive the second data from wireless signals having the second data from a second wireless device, as indicated by block 901. This may be the same as provided herein above. In block 903, the controller 428 is further configured to determine whether this second data has been received. The controller 428 is further configured to unlock the cashbox door lock mechanism 420 in response to receiving the first data if the second data has been received beforehand. Block 905 provides that the controller 428 causes, in response to determining that the second data has been received from the second wireless device, the cashbox door lock mechanism 420 to be moved into the second unlocked position in response to receiving the first data from the first wireless device. Once the second data has been received, the receipt of the first data causes the cashbox door lock mechanism to unlock. In the example above, a manager or high-level employee may provide the second data which allows another employee, like an attendant, afterwards to provide the first data and thereby unlock the cashbox door lock mechanism.

The receipt of the second data is therefore required before the first data is received in order for the first data to unlock the first cashbox door. Accordingly, the controller 428 is configured to prevent the first data from unlocking the cashbox door lock mechanism if the second data has not been received. Block 907 provides that the controller is configured to cause, in response to determining that the second data has not been received from the second wireless device, the cashbox door lock mechanism to remain in the second locked position in response to receiving the first data from the first wireless device. The receipt of the second data may be stored in the memory of the controller and accessed upon receipt of the first data. Once the first data has been received, a check may be made if the second data has been received and if so, then the cashbox door lock mechanism may be unlocked.

In some implementations, time-based controls may be used in the technique 900 involving receipt of the first and second data. For example, it may be advantageous to provide a limited window for receiving the second data. In another example, it may be advantageous to provide a limited window after which the second data is received to allow receipt of the first data to unlock the first cashbox door. In one instance, after one employee has provided the second data to the EGM, a time window of an hour may be provided to allow receipt of the first data to unlock the first cashbox door. If the first data is provided in that time period after the second data is received, the first cashbox door may be unlocked. If not, then the first cashbox door may remain locked.

In some instances, the controller is configured to determine whether the second data has been received from the second wireless device in a second time period. This may include storing a second time when the second data is received, like with block 801, and storing second information indicating the receipt of the second data both of which may be accessed once the first data has been received. For example, in response to receiving the first data, the controller may check its memory for data indicating that the second data has been received in the second time period. If so, then the controller may cause the cashbox door lock mechanism to be moved into the second unlocked position in response to receiving the first data from the first wireless device. If the controller determines that the second data has not been received from the second wireless device in the second time period, then the controller causes the cashbox door lock mechanism to remain in the second locked position in response to receiving the first data from the first wireless device.

Similarly, the controller may be configured to control access based on the timing of receiving both the second data and the first data. For example, the controller is configured to determine whether the first data has been received from the first wireless device in a first time period, like provided above, and whether the second data has been received from the second wireless device in a second time period, also like provided above. If the second data has been received within the second time period and the first data has been received in the first time period, then the cashbox door lock mechanism may be caused to move into the unlocked position. In some instances, the controller is configured to cause, in response to determining that the second data has been received from the second wireless device in the second time period, the cashbox door lock mechanism to be moved into the second unlocked position in response to receiving the first data from the first wireless device in the first time period. If one or the other is not true, then the cashbox door lock mechanism may remain closed. More specifically, the controller is configured to cause, in response to determining that the second data has not been received from the second wireless device in the second time period and/or that the first data has not been received from the first wireless device in the first time period, the cashbox door lock mechanism to remain in the second locked position in response to receiving the first data from the first wireless device. This may provide double time-based controls in which both the first and second data are required to be received in specific windows of time.

In some implementations, the EGM 401 may have a second cashbox door closer to the exterior of the EGM 401, such as an external door forming a surface of the EGM 401. Referring back to FIG. 4A, although the second cashbox door is not illustrated, the first cashbox door 408 may be considered interposed between the internal cashbox portion 410 and the second cashbox door. This second cashbox door may be rotatably coupled to the cabinet and configured to rotate between a third closed position and a third open position. The second cashbox door is configured to cover a second cashbox opening of the internal cashbox portion and to prevent access to the first cashbox door 408 and the internal cashbox portion 410 in the third closed position, and to provide access to the first cashbox door 408 in the third open position. The EGM 401 may also have a second cashbox door lock mechanism configured to be electronically actuated between a third locked position and a third unlocked position, to prevent the second cashbox door from moving out of the third closed position while in the third locked position, and to allow the second cashbox door to move out of the third closed position while in the third unlocked position. This second cashbox door lock mechanism may be configured like any of the door lock mechanisms provided herein.

The system 400 may be configured to control the locking and unlocking of the first and/or second cashbox doors based on receiving the second data. FIG. 9 provides these operations as optional steps. For example, the controller is configured to cause, in response to determining that the second data has been received from the second wireless device, the second cashbox door lock mechanism to be moved into the third unlocked position, as indicated in optional block 911. Further, the controller is configured to cause, in response to determining that the second data has not been received from the second wireless device, the second cashbox door lock mechanism to remain in the third locked position, as provided in optional block 913. If the first data is provided to the RF receiver, the controller is configured to cause the second cashbox door lock mechanism to remain in the third locked position if the second data has not been received.

The second cashbox door may also be controlled in a time-based manner like provided above. This may include determining whether the second data has been received from the second wireless device in a second time period. This determination may include determining a second time when the second signals are received. Further, the controller is configured to determine whether the second time is within the second time period, like described above. In response to determining that the second data has been received from the second wireless device in the second time period, the second cashbox door lock mechanism may be caused to be moved into the second unlocked position. The second data may be received from the second wireless device and in response to that receipt, the determinations may be made and the causation of the second cashbox door lock mechanism may occur. Also, the controller may be configured to cause, in response to determining that the second data has not been received from the second wireless device in the second time period, the second cashbox door lock mechanism to remain in the second locked position. In some instances, this may be the case when the first data is received; the second cashbox door lock mechanism remains in the third locked position in response to receiving the first data from the first wireless device.

In some implementations, an EGM may need to undergo service or otherwise be put offline. This may include an EGM issuing a request for service due to an issue or malfunction, such as running out of printer paper or an inoperative touchscreen. This may also include an employee issuing a request to service the EGM, or a periodic or time-based service request. The controller of the systems provided herein is configured to provide, in response to this need for service or for being taken offline, access to one of its doors in order to perform this service. For example, if the printer paper has run out and requires replacement, then access may be allowed to the internal compartment housing the printer paper. Access may be provided by allowing the provision of the first data to unlock a corresponding door in response to receiving an access authorization or information relating to this service.

For example, the controller may be configured to receive information relating to this service, such as instructions or authorization data for allowing the receipt of the first data to be analyzed. The controller may be further configured to cause, in response to receiving the information relating to the request for service and receiving the first data after receiving the information, the first door lock mechanism to move into the first unlocked position and the cashbox door lock mechanism to remain in the second locked position. In some implementations, a determination is not made as to whether the first data is associated with unlocking the first door. Rather, the receipt of the first data may result in unlocking the first door. Without receiving the information relating to the request or need for service, the first door may remain locked when the first data is received. The controller may therefore be configured to cause, in response to receiving the first data without receiving the information, the first door lock mechanism to remain in the first locked position and the cashbox door lock mechanism to remain in the second locked position.

In some implementations, specific employees may be provided access to the EGM in response to the EGM's need for service. This may include specific employees relating to the service needed, such as a display technician for an issue with a display or an attendant to replace printer paper, as well as specific employees on duty at the time of the service. In response to receiving information relating to the issue or need for service, the controller is configured to determine which employees are on duty at location where the EGM needing service is located, at the time the request for service is made, or both. Once this set of employees is determined, a controller is configured to retrieve and store door lock access data associated with the set of employees. This may include storing the unique door lock access data associated with a wireless device, like an RFID tag, possessed by each employee of the set of employees. In one example, this door lock access data of the set of employees may be stored in the credentials database stored by the controller, such as in the first access data thereby associated each wireless device of the set of employees with access to unlocking the first door.

One of these employees may provide the wireless RF signals possessing data to the RF receiver of the EGM having the service, and the controller is configured to determine if this data is in the first access data of the credentials database. For instance, the controller is configured to determine, in response to receiving the first data, whether the door lock access data indicates that the first data is associated with moving the first door lock mechanism to move into the first unlocked position. Because such information was retrieved and stored in the credentials database in response to receiving the information relating to the request for service, the determination is a match, and may be considered a “yes.” The controller is therefore configured to cause, in response to receiving the first data and determining that the door lock access data indicates that the first data is associated with moving the first door lock mechanism into the first unlocked position, the first door lock mechanism to move into the first unlocked position. This series of steps provides for on-the-fly and selective adjustments to access of an EGM based on a service request as well as available on duty personnel.

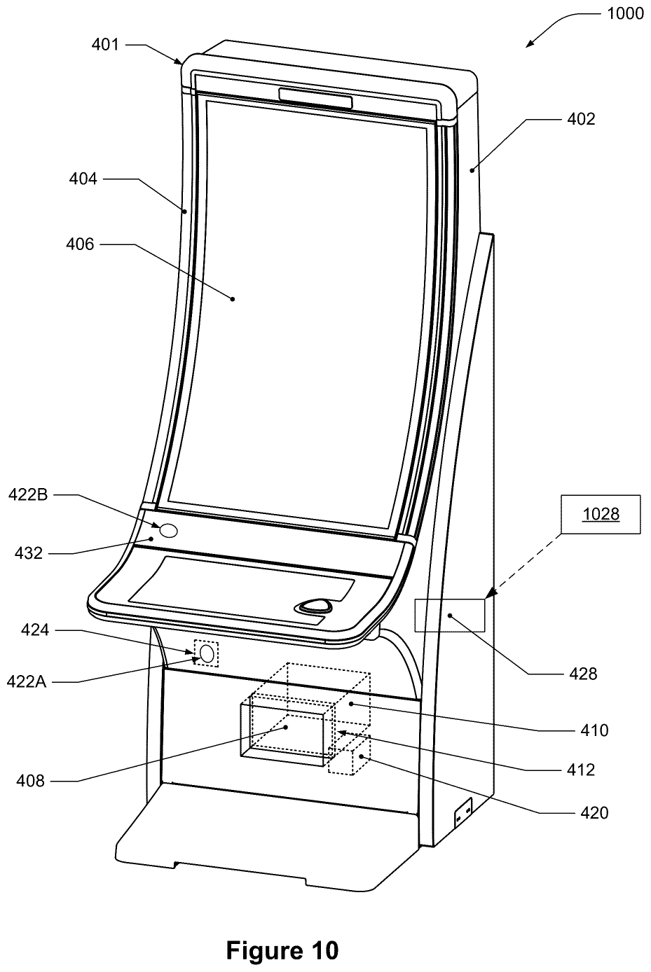

Changes to access of the EGM may be provided in other manners. For example, similar to above, an authorization may be transmitted to the EGM which adjusts the EGM's stored credentials database. In another example, the authorization may be configured to allow the receipt of wireless RF signals to unlock a door independent of the credentials database. In some implementations, an EGM may have a controller, like controller 428 provided herein, and the system may have a second controller communicatively coupled to the controller and configured to cause the authorization to be transmitted to the controller. FIG. 10 depicts another system in accordance with disclosed implementations. System 1000 has the EGM of FIGS. 4A and 4B, the controller 428 positioned inside the EGM 401, and a second controller 1028. The second controller 1028 is configured similar to controller 428, such as having one or more second processors and one or more second memories that store one or more second instructions configured to cause the one or more second processors to cause various actions.

Here, the second controller 1028 may be configured to cause the first authorization to be transmitted to the controller 428, as indicated by the dashed arrow spanning between the second controller 1028 and the controller 428 in FIG. 10. The instructions of the controller 428 are configured to cause the controller 428 to receive the authorization, and in some instances to store the first authorization in the memory 425. The first authorization may be configured to cause the receipt of the first data to cause one or both of the EGM's doors to be unlocked. This configuration may be adjusting the credentials database stored by the controller 428, replacing the credentials database stored by the controller 428 with a second credentials database, or it may be independent of the credentials database.

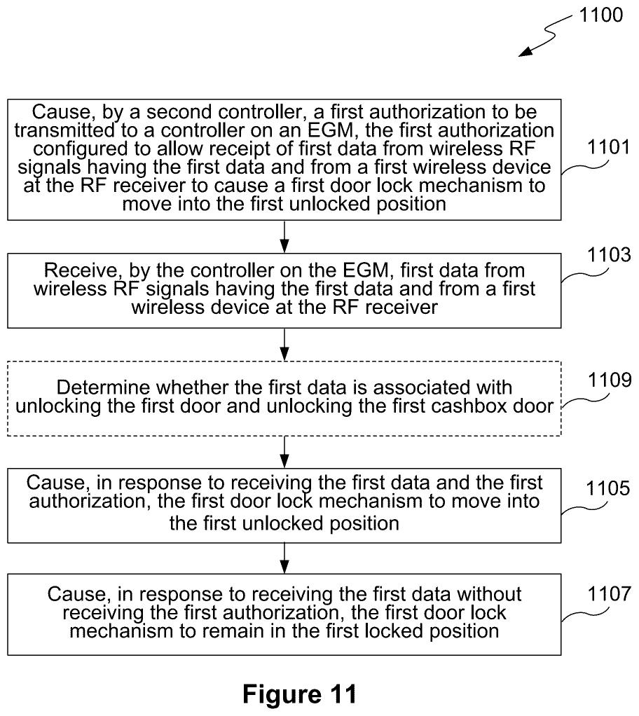

FIG. 11 depicts yet another example technique. Here, block 1101 of technique 1100 includes a second controller configured to cause a first authorization to be sent to the controller 428 on the EGM 401. The first authorization may result in the instructions of the controller 428 to be configured to cause the first door lock mechanism 418 of the first door 404 to move into the first unlocked position in response to receiving the first data. This configuration may omit determining whether the first data is associated with unlocking the first door. Rather, this configuration may be cause-and-effect such that the condition of receiving the first data causes the controller 428 to unlock the first door 404. For instance, in response to receiving the first authorization, the controller 428 may determine whether the first data has been received and if that determination is a yes, then the controller 428 may then cause the first door lock mechanism 418 to actuate to the first unlocked position. This instruction may also cause the first cashbox door 408 to remain locked. In some instances, without the receipt of the first authorization, the controller 428 may be configured to cause the first door lock mechanism 418 to remain in the first locked position when the first data is received.

As provided in FIG. 11, in block 1103 the first data is received by the RF receiver, like provided above with respect to block 501. In block 1105, in response to receiving this first data and the first authorization, the first door lock mechanism 418 is caused to move into the first unlocked position. As provided above, this unlocking may be based on the event of receiving the first data. In some optional implementations, the controller may be configured to determine whether the first data is associated with unlocking the first door and/or the first cashbox door, as indicted by optional block 1109. This optional determination step may be omitted in some instances. In block 1107, the first door lock mechanism is caused to remain locked if the first data is received without receiving the first authorization. Again, the determination of whether the first data is associated with unlocking the first door may not be performed after the first data is received in this example.

Although technique 1100 is provided with the first door, this technique may also be applied to the first cashbox door. For example, the receipt of the first authorization may cause the controller 428 of the EGM 401 to allow receipt of the first data to cause the cashbox door lock mechanism 420 to move to the second unlocked position. This may again omit the determination of whether the first data is associated with unlocking the cashbox door lock mechanism 420.

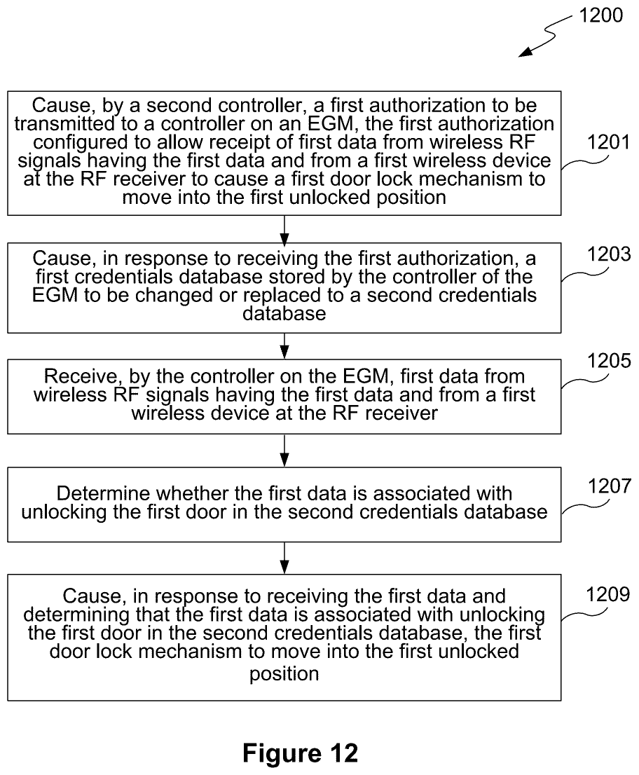

In another example, the authorization may provide a new or changed credentials database stored on the controller 428 of the EGM 401. FIG. 12 depicts another example technique. Here, block 1201 of technique 1200 includes a second controller causing a first authorization to be sent to a controller on the EGM. The first authorization, like with block 1101, results in the instructions of the controller 428 to be configured to cause the first door lock mechanism 418 of the first door 404 to move into the first unlocked position in response to receiving the first data. In block 1203, the first authorization is configured to cause a first credentials database stored on the controller 428 of the EGM 401 to be changed, adjusted, or replaced with a second credentials database. One or more aspects of the first credentials database may be adjusted or changed, such as adding data to the first access data which indicates the data that is associated with unlocking the first door lock mechanism. For example, this may include adding the first data, or a portion of the first data, to the first access data thereby causing the first data to be associated with unlocking the first door lock mechanism. The first authorization may also be configured to cause the first credentials database to be replaced, or overwritten, with a second credentials database. In some instances, the first authorization may contain the second credentials database while in others, the first and second credentials databases are stored on the controller of the EGM and the first authorization causes the second credentials databased to be used.

In block 1205, the first data is received from the wireless RF signals as provided herein above, such as block 501. In block 1207, the controller is configured to determine whether the first data is associated with unlocking the first door in the second credentials database. This determination may also be made like provided above, and here, the second credentials database is used. This second credentials database may be the adjusted first credentials database or a new credentials database. In one example, a comparison is made as to whether the first data, or a portion thereof, is located within the second credentials database, such as the first access data that indicates which data is associated with unlocking the first lock mechanism. If it is determined that the first data is associated with unlocking the first door lock mechanism 418 in the second credentials database, e.g., the first data is listed in the second credentials database, then the first door 404 may be unlocked. Accordingly, per block 1209, the controller is configured to cause, in response to receiving the first data and then determining that first data is associated with unlocking the first lock mechanism in the second credentials database, the first door lock mechanism 418 to move to the first unlocked position. Although this technique is illustrated with the first door, it is equally applicable to the first cashbox door. For example, the second credentials database may indicate that the first data is associated with unlocking the first cashbox door and the controller may be configured to unlock the first cashbox door in response to receiving the first data.

In some implementations, it may be advantageous to log or store various information about the access, and attempted access, to an EGM. This may include which personnel unlocked and opened one or more EGM doors, as well as the date and time of the access. Accordingly, the systems herein may be configured to log or otherwise store information associated with the first data. This may include the instructions of the controller configured to cause the storing, in response to receiving the first data, information associated with the first data. This information may include a time the first data was received, a date the first data was received, a name and/or ID of a person associated with the first data, an employee categorization of the person associated with the first data, whether the first data resulted in unlocking the first door, whether the first data resulted in unlocking the first cashbox door, or a combination thereof. The information may be stored on the memory of the controller and also transmitted to another device, such as a second controller separate from the EGM.

There may also be advantages in providing additional locking of the cashbox and storing information associated with access to the cashbox. In some implementations, the EGM may include a cashbox lock mechanism, separate from the first cashbox door, that directly engages with and locks the cashbox to the EGM. For example, referring back to system 400 in FIG. 4B, the EGM may have a cashbox lock mechanism 430 coupled to the cabinet and having a bolt, tongue, or flange configured to engage with a mortise, strike plate, or other feature on the cashbox. The cashbox lock mechanism 430 may be positioned adjacent to the internal cashbox portion 410 and may be configured like any other locking mechanism provided herein. The cashbox lock mechanism 430 is also configured to be electronically actuated between a cashbox locked position and a cashbox unlocked position, configured to prevent removal of the cashbox from the electronic gaming machine in the cashbox locked position, and configured to allow removal of the cashbox from the electronic gaming machine in the cashbox unlocked position. The instructions of the controller 428 may be further configured to determine whether the first data is associated with unlocking the cashbox lock mechanism and if so, cause the cashbox lock mechanism to move into the cashbox unlocked position.

The EGM 401 may have a third RF receiver 422C, illustrated in FIG. 4B, and the controller 428 may be configured to unlock the cashbox lock mechanism 430 when the first data is received at a third RF receiver 422C or fourth RF receiver 422D. In some implementations, the third RF receiver 422C is positioned inside the cabinet 402, such as adjacent to or inside the internal cashbox portion 410, and coupled to the cabinet 402. In other implementations, the fourth RF receiver 422D is coupled to a cashbox 434. The instructions of the controller 428 may be configured to cause the receipt of the first data provided to the third RF receiver 422C or fourth RF receiver 422D, and to determine that the first data has been received for the first wireless device at the third RF receiver 422C or fourth RF receiver 422D. The controller 428 may be further configured to cause, in response to determining that the first data is associated with unlocking the cashbox lock mechanism 430 and that the first data has been received from the first wireless device at the second RF received, the cashbox lock mechanism 430 to move into the cashbox unlocked position. These configurations may provide additional security and access controls for the cashbox 434 itself. In some instances, the data provided to the third RF receiver 422C or fourth RF receiver 422D may also be stored to further log persons, e.g., as described above, who physically removed the cashbox.

As provided above, the first wireless device may be a passive or active device. Examples of a passive wireless device include a passive RFID device, Bluetooth such as Bluetooth low energy (BLE), an NFC device. In some instances, an RFID device may be a part of an employee's mobile device, such as a telephone, table, watch. In some instances, a person may position an RFID device, or other passive RF device, within their body. For example, a passive RFID tag may be surgically implanted underneath a person's skin, such as in a person's hand, wrist, or arm. Examples of an active wireless device include active RFID device or tag, active NFC device, Bluetooth classic, or the like.

Unless otherwise specified, the illustrated embodiments are to be understood as providing example features of varying detail of some embodiments. Thus, unless otherwise specified, the features, components, modules, layers, films, regions, aspects, structures, etc. (hereinafter individually or collectively referred to as an “element” or “elements”), of the various illustrations may be otherwise combined, separated, interchanged, and/or rearranged without departing from the teachings of the disclosure.

The terminology used herein is for the purpose of describing some embodiments and is not intended to be limiting. As used herein, the singular forms, “a,” “an,” and “the” are intended to include the plural forms as well, unless the context clearly indicates otherwise. It is to be understood that the phrases “for each <item>of the one or more <items>,” “each <item>of the one or more <items>,” and/or the like, if used herein, are inclusive of both a single-item group and multiple-item groups, i.e., the phrase “for. each” is used in the sense that it is used in programming languages to refer to each item of whatever population of items is referenced. For example, if the population of items referenced is a single item, then “each” would refer to only that single item (despite dictionary definitions of “each” frequently defining the term to refer to “every one of two or more things”) and would not imply that there must be at least two of those items. Similarly, the term “set” or “subset” should not be viewed, in itself, as necessarily encompassing a plurality of items—it is to be understood that a set or a subset can encompass only one member or multiple members (unless the context indicates otherwise). The terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art. Accordingly, the term “substantially” as used herein, unless otherwise specified, means within 5% of a referenced value. For example, substantially perpendicular means within ±5% of parallel.

When an element is referred to as being “on,” “connected to,” or “coupled to” another element, it may be directly on, directly connected to, or directly coupled to the other element or at least one intervening element may be present. When, however, an element is referred to as being “directly on,” “directly connected to,” or “directly coupled to” another element, there are no intervening elements present. Other terms and/or phrases if used herein to describe a relationship between elements should be interpreted in a like fashion, such as “between” versus “directly between,” “adjacent” versus “directly adjacent,” “on” versus “directly on,” etc. Further, the term “connected” may refer to physical, electrical, and/or communication. For example, “electrically connected” is used with respect to components that are connected to form an electric connection.

As used herein, the phrase “operatively connected” is to be understood as referring to a state in which two components and/or systems are connected, either directly or indirectly, such that, for example, at least one component or system can control the other. For instance, a controller may be described as being operatively connected with (or to) a resistive heating unit, which is inclusive of the controller being connected with a sub-controller of the resistive heating unit that is electrically connected with a relay that is configured to controllably connect or disconnect the resistive heating unit with a power source that is capable of providing an amount of power that is able to power the resistive heating unit so as to generate a desired degree of heating. The controller itself likely will not supply such power directly to the resistive heating unit due to the current(s) involved, but it is to be understood that the controller is nonetheless operatively connected with the resistive heating unit.

The term “between,” as used herein and when used with a range of values, is to be understood, unless otherwise indicated, as being inclusive of the start and end values of that range. For example, between 1 and 5 is to be understood to be inclusive of the numbers 1, 2, 3, 4, and 5, not just the numbers 2, 3, and 4.

The use, if any, of ordinal indicators, e.g., (a), (b), (c) . . . or the like, in this disclosure and claims is to be understood as not conveying any particular order or sequence, except to the extent that such an order or sequence is explicitly indicated. For example, if there are three steps labeled (i), (ii), and (iii), it is to be understood that these steps may be performed in any order (or even concurrently, if not otherwise contraindicated) unless indicated otherwise. For example, if step (ii) involves the handling of an element that is created in step (i), then step (ii) may be viewed as happening at some point after step (i). Similarly, if step (i) involves the handling of an element that is created in step (ii), the reverse is to be understood. It is also to be understood that use of the ordinal indicator “first” herein, e.g., “a first item,” should not be read as suggesting, implicitly or inherently, that there is necessarily a “second” instance, e.g., “a second item.”

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A system for electronically locking and unlocking locks of an electronic gaming machine, the system comprising:
the electronic gaming machine having:
a cabinet defining an internal compartment having a first internal portion and an internal cashbox portion configured to receive a cashbox,
a first door rotatably coupled to the cabinet and configured to rotate between a first closed position and a first open position, to cover a first opening of the first internal portion and prevent access to the first internal portion in the first closed position, and to provide access to the first internal portion in the first open position,
a first door lock mechanism configured to be electronically actuated between a first locked position and a first unlocked position, to prevent the first door from moving out of the first closed position while in the first locked position, and to allow the first door to move out of the first closed position while in the first unlocked position,
a first cashbox door rotatably coupled to the cabinet and configured to rotate between a second closed position and a second open position, to cover a cashbox opening of the internal cashbox portion and prevent access to the internal cashbox portion in the second closed position, and to provide access to the internal cashbox portion in the second open position,
a cashbox door lock mechanism configured to be electronically actuated between a second locked position and a second unlocked position, to prevent the first cashbox door from moving out of the second closed position while in the second locked position, and to allow the first cashbox door to move out of the second closed position while in the second unlocked position, and
a radio frequency (RF) receiver coupled to the cabinet and configured to receive wireless RF signals having data; and
a controller having one or more processors and one or more memories that store instructions for controlling the first door lock mechanism and the cashbox door lock mechanism, wherein the instructions are configured to cause the one or more processors to:
receive first data from the wireless RF signals having the first data and received from a first wireless device at the RF receiver,
determine whether the first data is associated with unlocking the first door and unlocking the first cashbox door,
cause, in response to determining that the first data is associated with unlocking the first door and not associated with unlocking the first cashbox door, the first door lock mechanism to move into the first unlocked position and the cashbox door lock mechanism to remain in the second locked position,
cause, in response to determining that the first data is associated with unlocking the first cashbox door and not associated with unlocking the first door, the cashbox door lock mechanism to move into the second unlocked position and the first door lock mechanism to remain in the first locked position, and
cause, in response to determining that the first data is associated with unlocking the first door and unlocking the first cashbox door, the first door lock mechanism to move into the first unlocked position and the cashbox door lock mechanism to move into the second unlocked position.

2. The system of claim 1, wherein the instructions are further configured to cause the one or more processors to:
receive, while the first door lock mechanism is in the first unlocked position, the first data from the wireless RF signals having the first data and received from the first wireless device at the RF receiver,
cause, in response to receiving the first data while the first door lock mechanism is in the first unlocked position, the first door lock mechanism to move into the first locked position,
receive, while the cashbox door lock mechanism is in the second unlocked position, the first data from the wireless RF signals having the first data and received from the first wireless device at the RF receiver, and
cause, in response to receiving the first data while the cashbox door lock mechanism is in the second unlocked position, the cashbox door lock mechanism to move into the second locked position.

3. The system of claim 1, wherein the instructions are further configured to cause the one or more processors to:
receive wireless RF signals having the first data from the first wireless device at a first time,
determine whether the first data is associated with unlocking the first door and whether the first time is within a first authorized time period,
determine whether the first data is associated with unlocking the first cashbox door and whether the first time is within a second authorized time period,
cause, in response to determining that the first data is associated with unlocking the first door and that the first time is within the first authorized time period, the first door lock mechanism to move into the first unlocked position,
cause, in response to determining that the first data is not associated with unlocking the first door or that the first time is outside the first authorized time period, the first door lock mechanism to remain in the first locked position,
cause, in response to determining that the first data is associated with unlocking the cashbox door and that the first time is within the second authorized time period, the cashbox door lock mechanism to move into the second unlocked position, and
cause, in response to determining that the first data is not associated with unlocking the cashbox door or that the first time is outside the second authorized time period, the cashbox door lock mechanism to remain in the second locked position.

4. The system of claim 1, wherein the instructions are further configured to cause the one or more processors to:
receive wireless RF signals having second data from a second wireless device,
determine whether the second data has been received from the second wireless device,
cause, in response to determining that the second data has been received from the second wireless device, the cashbox door lock mechanism to be moved into the second unlocked position in response to receiving the first data from the first wireless device, and
cause, in response to determining that the second data has not been received from the second wireless device, the cashbox door lock mechanism to remain in the second locked position in response to receiving the first data from the first wireless device.

5. The system of claim 4, wherein the instructions are further configured to cause the one or more processors to:
determine whether the second data has been received from the second wireless device in a second time period,
cause, in response to determining that the second data has been received from the second wireless device in the second time period, the cashbox door lock mechanism to be moved into the second unlocked position in response to receiving the first data from the first wireless device, and
cause, in response to determining that the second data has not been received from the second wireless device in the second time period, the cashbox door lock mechanism to remain in the second locked position in response to receiving the first data from the first wireless device.

6. The system of claim 5, wherein the instructions are further configured to cause the one or more processors to:
determine whether the first data has been received from the first wireless device in a first time period,
cause, in response to determining that the second data has been received from the second wireless device in the second time period, the cashbox door lock mechanism to be moved into the second unlocked position in response to receiving the first data from the first wireless device in the first time period, and
cause, in response to determining that the second data has not been received from the second wireless device in the second time period and/or that the first data has not been received from the first wireless device in the second time period, the cashbox door lock mechanism to remain in the second locked position in response to receiving the first data from the first wireless device.

7. The system of claim 4, wherein:
the electronic gaming machine further comprises:
a second cashbox door rotatably coupled to the cabinet and configured to rotate between a third closed position and a third open position, to cover a second cashbox opening of the internal cashbox portion and to prevent access to the first cashbox door and the internal cashbox portion in the third closed position, and to provide access to the first cashbox door in the third open position, and
a second cashbox door lock mechanism configured to be electronically actuated between a third locked position and a third unlocked position, to prevent the second cashbox door from moving out of the third closed position while in the third locked position, and to allow the second cashbox door to move out of the third closed position while in the third unlocked position, and
the instructions are further configured to cause the one or more processors to:
cause, in response to determining that the second data has been received from the second wireless device, the second cashbox door lock mechanism to be moved into the third unlocked position, and
cause, in response to determining that the second data has not been received from the second wireless device, the second cashbox door lock mechanism to remain in the third locked position.

8. The system of claim 7, wherein the instructions are further configured to cause the one or more processors to:
determine whether the second data has been received from the second wireless device in a second time period,
cause, in response to determining that the second data has been received from the second wireless device in the second time period, the second cashbox door lock mechanism to be moved into the third unlocked position in response to receiving the second data from the second wireless device, and
cause, in response to determining that the second data has not been received from the second wireless device in the second time period, the second cashbox door lock mechanism to remain in the third locked position in response to receiving the first data from the first wireless device.

9. The system of claim 1, wherein the instructions are further configured to cause the one or more processors to:
receive information relating to a request for service for the electronic gaming machine,
cause, in response to receiving the information relating to the request for service and receiving the first data after receiving the information, the first door lock mechanism to move into the first unlocked position and the cashbox door lock mechanism to remain in the second locked position, and
cause, in response to receiving the first data without receiving the information, the first door lock mechanism to remain in the first locked position and the cashbox door lock mechanism to remain in the second locked position.

10. The system of claim 9, wherein the instructions are further configured to cause the one or more processors to:
determine, in response to receiving the information relating to the request for service, a set of employees that are on duty at a location of the electronic gaming machine and at a time the request for service is received,
retrieve door lock access data associated with the set of employees and store the door lock access data on the one or more memories, and
determine, in response to receiving the first data, whether the door lock access data indicates that the first data is associated with moving the first door lock mechanism to move into the first unlocked position, and
cause, in response to receiving the first data and determining that the door lock access data indicates that the first data is associated with causing the first door lock mechanism to move into the first unlocked position, the first door lock mechanism to move into the first unlocked position.

11. The system of claim 1, further comprising a second controller on the electronic gaming machine and having one or more second processors and one or more second memories that store second instructions for causing a first authorization to be transmitted to the controller, wherein:
the controller is positioned in the electronic gaming machine,
the first authorization is configured to allow the receipt of the first data to cause the first door lock mechanism to move into the first unlocked position and the cashbox door lock mechanism to remain in the second locked position, and
the instructions are configured to cause the one or more second processors to:
receive the first authorization,
cause, in response to receiving the first authorization and receiving the first data after receiving the first authorization, the first door lock mechanism to move into the first unlocked position and the cashbox door lock mechanism to remain in the second locked position, and
cause, in response to receiving the first data without receiving the first authorization, the first door lock mechanism to remain in the first locked position and the cashbox door lock mechanism to remain in the second locked position.

12. The system of claim 1, further comprising a second controller on the electronic gaming machine and having one or more second processors and one or more second memories that store second instructions for causing a first authorization to be transmitted to the controller, wherein:
the controller is positioned in the electronic gaming machine,
the first authorization is configured to allow the receipt of the first data to cause the cashbox door lock mechanism to move into the second unlocked position and the first door lock mechanism to remain in the first locked position, and
the instructions are configured to cause the one or more processors to:
receive the first authorization,
cause, in response to receiving the first authorization and receiving the first data after receiving the first authorization, the cashbox door lock mechanism to move into the second unlocked position and the first door lock mechanism to remain in the first locked position, and
cause, in response to receiving the first data without receiving the first authorization, the first door lock mechanism to remain in the first locked position and the cashbox door lock mechanism to remain in the second locked position.

13. The system of claim 1, further comprising a second controller on the electronic gaming machine and having one or more second processors and one or more second memories that store second instructions for causing a first authorization to be transmitted to the controller, wherein:
the controller is positioned in the electronic gaming machine,
the first authorization is configured to change or replace a first credentials database with a second credentials database that associates the first data with unlocking the first door, and
the instructions are configured to cause the one or more processors to:
receive the first authorization,
change or replace, in response to receiving the first authorization, the first credentials database with the second credentials database,
determine whether the first data is associated with unlocking the first door in the second credentials database, and
cause, in response to determining that the first data is associated with unlocking the first door in the second credentials database, the first door lock mechanism to move into the first unlocked position.

14. The system of claim 1, wherein:
determining whether the first data is associated with unlocking the first door comprises comparing the first data to a credentials database having first access data indicating which data is authorized to unlock the first door, and
determining whether the first data is associated with unlocking the first cashbox door comprises comparing the first data to the credentials database having second access data indicating which data is authorized to unlock the first cashbox door.

15. The system of claim 14, wherein the credentials database is stored on the one or more memories and the controller is on the electronic gaming machine.

16. The system of claim 1, wherein:
the instructions are configured to cause the one or more processors to store, in response to receiving the first data, identification information associated with the first data, and
the identification information comprises a time the first data was received, a date the first data was received, an identification of a person associated with the first data, an employee categorization of the person associated with the first data, or a combination thereof.

17. The system of claim 1, further comprising a cashbox lock mechanism configured to be electronically actuated between a cashbox locked position and a cashbox unlocked position, configured to prevent removal of the cashbox from the electronic gaming machine in the cashbox locked position, and configured to allow removal of the cashbox from the electronic gaming machine in the cashbox unlocked position, wherein the instructions are further configured to cause the one or more processors to:
cause, in response to determining that the first data is associated with unlocking the cashbox lock mechanism, the cashbox lock mechanism to move into the cashbox unlocked position.

18. The system of claim 17, further comprising a second RF receiver configured to receive RF signals having data, wherein the instructions are further configured to cause the one or more processors to:
receive first data from the wireless RF signals having the first data and received from the first wireless device at the second RF receiver,
determine that the first data has been received from the first wireless device at the second RF receiver,
cause, in response to determining that the first data is associated with unlocking the cashbox lock mechanism and that the first data has been received from the first wireless device at the second RF received, the cashbox lock mechanism to move into the cashbox unlocked position.

19. The system of claim 18, wherein the second RF receiver is coupled to the cabinet or to a cashbox.

20. The system of claim 1, wherein the RF receiver is configured to receive radio frequency (RF) signals comprising radio frequency identification (RFID) signals, near field communication (NFC) signals, Bluetooth signals, or a combination thereof.
